(19) United States
(12) Patent Application Publication
(10) Pub. No.: US 2015/0363450 A1
(43) Pub. Date: Dec. 17, 2015

(54) BAYESIAN SEQUENTIAL PARTITION SYSTEM IN MULTI-DIMENSIONAL DATA SPACE AND COUNTING ENGINE THEREOF

(71) Applicant: National Chiao Tung University, Hsinchu City (TW)

(72) Inventors: Chen-Yi Lee, Hsinchu City (TW); Hsie-Chia Chang, Hsinchu City (TW); Shu-Yu Hsu, Hsinchu City (TW); Chih-Lung Chen, Hsinchu City (TW); Chang-Hung Tsai, Hsinchu City (TW); Wing-Hung Wong, Stanford, CA (US); Tung-Yu Wu, Stanford, CA (US); Ying-Siou Liao, Hsinchu City (TW); Chia-Ching Chu, Hsinchu City (TW); Fang-Ju Ku, Hsinchu City (TW)

(21) Appl. No.: 14/738,248

(22) Filed: Jun. 12, 2015

Related U.S. Application Data
(60) Provisional application No. 62/011,057, filed on Jun. 12, 2014.

(51) Int. Cl. G06F 17/30

(52) U.S. Cl. CPC G06F 17/30345; G06F 17/30592

(57) ABSTRACT

A counting engine for a Bayesian sequential partition system in a D-dimensional data space is provided. The counting engine includes a filtering module and a counting module. The filtering module is used for comparing at least one under-test data point with D boundary information corresponding to a sub-region, and consequently generating D flag sets. The counting module is connected with the filtering module. The counting module determines whether the at least one under-test data point lies in the sub-region, and consequently generates a result signal. A counting value corresponding to the sub-region is selectively accumulated by the counting module according to the result signal.

This application claims the benefit of U.S. provisional application Ser. No. 62/011,057, filed Jun. 12, 2014, the disclosure of which are entirety incorporated herein by reference.

### FIELD OF THE INVENTION

The present invention relates to a density analysis system, and more particularly to a Bayesian sequential partition system in a multi-dimensional data space and a counting engine thereof.

### BACKGROUND OF THE INVENTION

With increasing development of science and technology, a massive amount of data is generated by field researches, technology developments, financial transactions or networking technologies. Before the data is analyzed, the data is possibly valueless. After the data is properly processed and analyzed, the meanings and values of the data can be further interpreted and manifested. If the size of the data is as big as Petabyte or Eexabyte, it is necessary to automatically process and analyze the big data.

Conventionally, plural application programs simultaneously run in dozens, hundreds or thousands of servers to parallel analyze the big data. In other words, the equipment cost and the operating cost for processing and analyzing the big data are very high. Moreover, if the amount of the data is massive, the speed of analyzing the big data is still very slow. Therefore, it is important to increase the speed of analyzing the big data.

### SUMMARY OF THE INVENTION

An embodiment of the present invention provides a counting engine for a Bayesian sequential partition system in a D-dimensional data space. The counting engine includes a filtering module and a counting module. The filtering module compares at least one under-test data point with D boundary information corresponding to a sub-region, and consequently generates D flag sets. The counting module is connected with the filtering module. The counting module determines whether the at least one under-test data point lies in the sub-region, and consequently generates a result signal. A counting value corresponding to the sub-region is selectively accumulated by the counting module according to the result signal.

Another embodiment of the present invention provides a Bayesian sequential partition system in a multi-dimensional data space. The Bayesian sequential partition system is connected with a data point storage unit. Moreover, plural dimension values of plural data points along plural data dimensions are stored in the data point storage unit. The Bayesian sequential partition system includes a controller, a comparison criterion memory, a counting engine and a counting result memory. The controller generates a region information corresponding to a region. The comparison criterion memory is connected with the controller for temporarily storing the region information. The counting engine is connected with the comparison criterion memory and the data point storage unit. The counting engine cuts the region into a first sub-region and a second sub-region according to a first simulated cut. Moreover, the counting engine generates a filtering condition for filtering the plural data points according to the region information and counts a first number of data points in the first sub-region. The counting result memory is connected with the counting engine and the controller for temporarily storing the first number and transmitting the first number to the controller. The controller records a second number of the data points which are included in the region and obtains a third number of data points by subtracting the first number from the second number. The controller realizes that the third number of data points are included in the second sub-region, and the controller acquires a first cutting weight corresponding to the first simulated cut according to the first number and the third number.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a flowchart illustrating a method of performing a BSP algorithm in a data space;

FIG. 2A schematically illustrates a cutting process of performing a BSP algorithm in a two-dimensional data space;

FIG. 2B schematically illustrates a cutting process of performing a BSP algorithm in a three-dimensional data space;

FIG. 2C schematically illustrates the normalized values of a two-dimensional data space after a massive number of raw data are normalized;

FIG. 2D schematically illustrates the result of plural cutting operations on the two-dimensional data space of FIG. 2C;

FIG. 3 is a flowchart illustrating a process of performing the P-th cutting operation on a D-dimensional data space;

FIG. 4 is a schematic functional block diagram illustrating a BSP system in a multi-dimensional data space according to an embodiment of the present invention;

FIG. 5A schematically illustrates an initial region set in a three-dimensional data space;

FIG. 5B schematically illustrating the processes of performing various simulated cuts on the region A of the initial region set and the approach of calculating the data point number of the sub-regions;

FIG. 6A is a schematic diagram illustrating a first exemplary filtering and counting module used in FIG. 4;

FIG. 6B schematically illustrates the operations of the comparing circuit and the flag generator of FIG. 6A;

FIG. 6C is a schematic diagram illustrating the cutting trailer of FIG. 6A;

FIG. 7A is a schematic diagram illustrating a second exemplary filtering and counting module used in FIG. 4;

FIG. 7B schematically illustrates the operations of the comparing circuit and the flag generator of FIG. 7A;

FIG. 7C is a schematic circuit diagram illustrating the cutting trailer array of FIG. 7A;

FIG. 8A is a schematic diagram illustrating a third exemplary filtering and counting module used in FIG. 4;

FIG. 8B schematically illustrates the operations of the comparing circuit and the flag generator of FIG. 8A;

FIG. 8C is a schematic diagram illustrating the cutting trailer array of FIG. 8A;

FIG. 8D is a schematic circuit diagram illustrating the cutting trailer array of FIG. 8C;

FIG. 9 is a schematic functional block diagram illustrating a BSP system in a multi-dimensional data space according to another embodiment of the present invention;

FIG. 10 is a schematic functional block diagram illustrating a BSP system in a multi-dimensional data space according to a further embodiment of the present invention;

FIGS. 11A, 11B, 11C and 11D schematically illustrate some examples of configuring the counting engine of the present invention;

FIG. 12 schematically illustrates a counting chip with plural configurable counting engines;

FIG. 13 schematically illustrates the architecture of a BSP system with plural serially-connected counting chips according to an embodiment of the present invention; and

FIG. 14 schematically illustrates the architecture of a BSP system with plural parallel-connected counting chips according to an embodiment of the present invention.

### DETAILED DESCRIPTION OF PREFERRED EMBODIMENTS

A Bayesian sequential partition algorithm (also referred as a BSP algorithm) will be illustrated as follows. In the multi-dimensional data space, each data may be considered as a data point in the data space. The location of the data point is determined according to the values of the data point in different dimensions. In statistics, a data density is an important factor in big data analysis because the data density may indicate the concentration of the data points in the data space. After the data density is acquired, the key information about the distribution of the data points can be further analyzed.

As known, the Bayesian sequential partition algorithm is a method of estimating a data-driven probability density function. Being a powerful machine learning technology, the BSP algorithm is used to effectively cut the data space into plural regions by a sequential binary partitioning approach. These regions are distinguished according to the distribution of the data points.

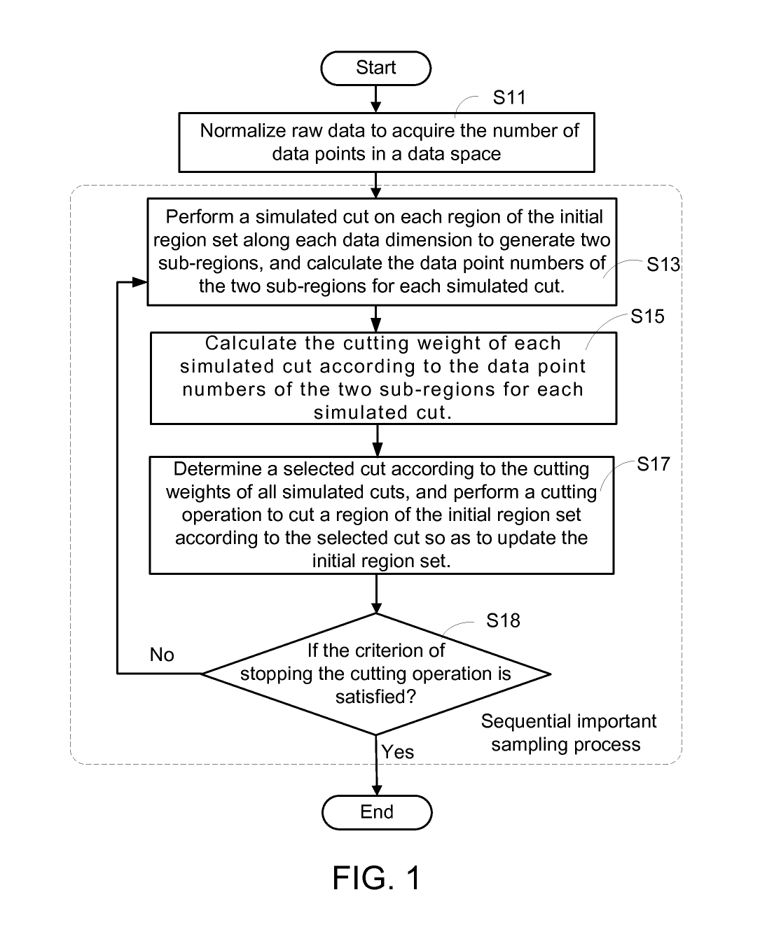

FIG. 1 is a flowchart illustrating a method of performing a BSP algorithm in a data space. Firstly, raw data are normalized and the number of data points in a data space is acquired (Step S11). Then, the data space is used as an initial region set. Then, a simulated cut is performed on each region of the initial region set along each data dimension to generate two sub-regions, and the data point numbers of the two sub-regions for each simulated cut are calculated (Step S13). Then, the cutting weight of each simulated cut is calculated according to the data point numbers of the two sub-regions for each simulated cut (Step S15). Then, a selected cut is determined according to the cutting weights of all simulated cuts, and a cutting operation is performed to cut a region of the initial region set according to the selected cut, so that an updated initial region set is generated (Step S17). Then, the step S18 is performed to determine whether the criterion of stopping the cutting operation is satisfied. If the stopping criterion is not satisfied, the step S13 is repeatedly done. Whereas, if the stopping criterion is satisfied, the flowchart is ended. Moreover, the steps S13, S15, S17 and S118 are collaboratively referred as a sequential important sampling (SIS) process of the BSP algorithm. The method of performing the BSP algorithm in a two-dimensional data space and in a three-dimensional data space will be illustrated as follows.

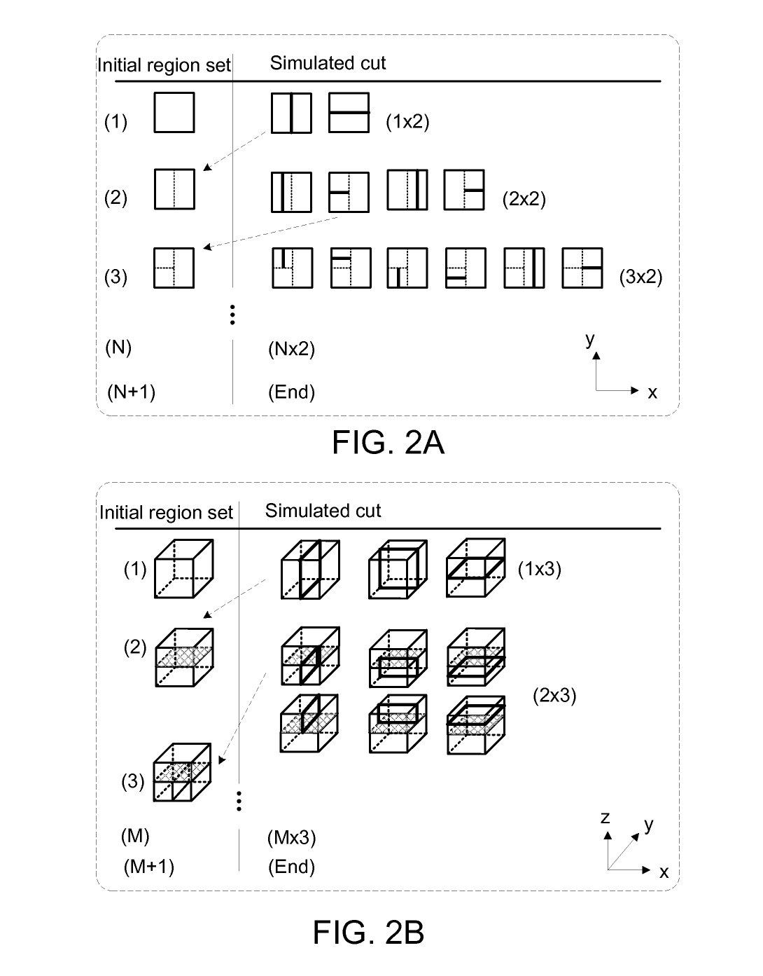

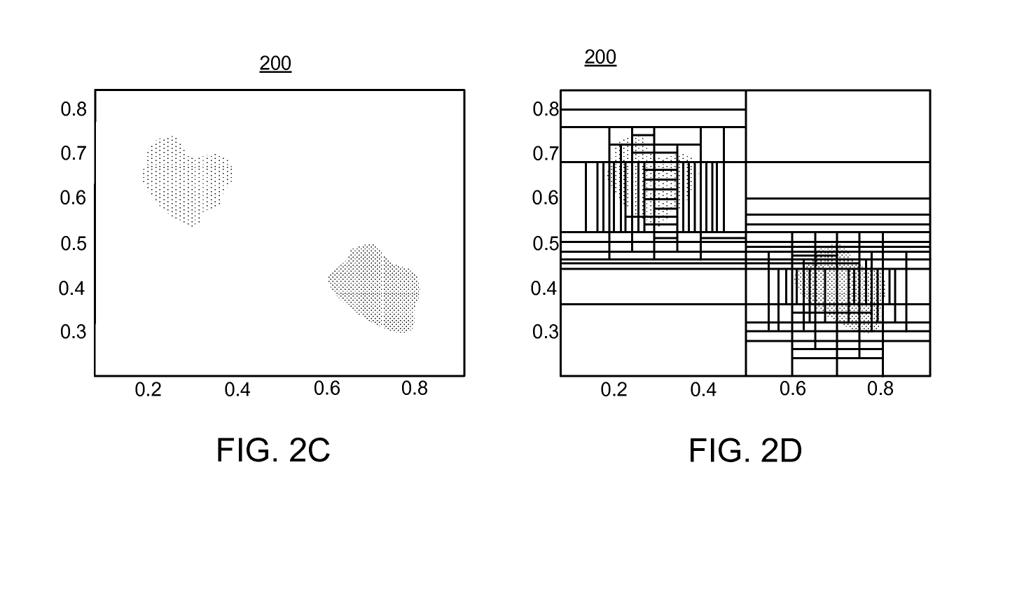

FIG. 2A schematically illustrates a cutting process of performing a BSP algorithm in a two-dimensional data space. It is assumed that each data point contains two fields. The two fields are correlated with two data dimensions, respectively. That is, the data space may be indicated as a two-dimensional plane (i.e., data dimension d=2). In this context, the X-axis direction is defined as a first data dimension, and the Y-axis direction is defined as a second data dimension. Moreover, after a massive number of raw data are normalized, plural data points (not shown) distributed over a planar data space (i.e., the two-dimensional data space) are obtained. The normalized value of each data dimension is in the range between 0 and 1. After all raw data are normalized, the locations of all data points in the data space are realized according to the values of the data points along various data dimensions, and the number of all data points is calculated.

Please refer to the initial region set (1). The initial region set (1) is the whole data space, and the data point number of the data space is known. Moreover, since the data space has only one region, there are a total of two simulated cuts. By the first simulated cut along the first data dimension, the region is cut into two sub-regions, including a left sub-region and a right sub-region. Moreover, the cutting weight of the first simulated cut is calculated according to the data point numbers of the left sub-region and the right sub-region. Moreover, by the second simulated cut along the second data dimension, the region is cut into two sub-regions, including an upper sub-region and a lower sub-region. Moreover, the cutting weight of the second simulated cut is calculated according to the data point numbers of the upper sub-region and the lower sub-region. According to the cutting weights of the two simulated cuts, one of the two simulated cuts is determined as a selected cut. For example, if the first simulated cut is determined as the selected cut, a first cutting operation is consequently performed on the region along the first data dimension. Under this circumstance, the initial region set (1) is updated to the initial region set (2) with a left region and a right region.

Please refer to the initial region set (2). The initial region set (2) contains the left region and the right region, and the data point numbers of the left region and the right region are known. Moreover, since two simulated cuts are performed on each region along two data dimensions, there are a total of four (i.e., 2×2=4) simulated cuts. In particular, the first simulated cut and the second simulated cut are performed on the left region, and the third simulated cut and the fourth simulated cut are performed on the right region.

By the first simulated cut, the left region of the initial region set (2) is simulatively cut along the first data dimension to obtain a left sub-region and a right sub-region. Moreover, the cutting weight of the first simulated cut is calculated according to the data point numbers of the left sub-region and the right sub-region of the left region. By the second simulated cut, the left region of the initial region set (2) is simulatively cut along the second data dimension to obtain an upper sub-region and a lower sub-region. Moreover, the cutting weight of the second simulated cut is calculated according to the data point numbers of the upper sub-region and the lower sub-region of the left region. By the third simulated cut, the right region of the initial region set (2) is simulatively cut along the first data dimension to obtain a left sub-region and a right sub-region. Moreover, the cutting weight of the third simulated cut is calculated according to the data point numbers of the left sub-region and the right sub-region of the right region. By the fourth simulated cut, the right region of the initial region set (2) is simulatively cut along the second data dimension to obtain an upper sub-region and a lower sub-region. Moreover, the cutting weight of the fourth simulated cut is calculated according to the data point numbers of the upper sub-region and the lower sub-region of the right region.

According to the cutting weights of these four simulated cuts, one of the four simulated cuts is determined as a selected cut. For example, if the second simulated cut for the initial region set (2) is determined as the selected cut, a second cutting operation is consequently performed on the data space. Under this circumstance, the initial region set (3) with an upper left region, a lower left region and a right region is the updated initial region set.

Please refer to the initial region set (3). The initial region set (3) contains the upper left region, the lower left region and the right region, and the data point numbers of these regions are known. Moreover, since two simulated cuts are performed on each region along two data dimensions, there are a total of six (i.e., 3×2=6) simulated cuts. In particular, the first simulated cut and the second simulated cut are performed on the upper left region, the third simulated cut and the fourth simulated cut are performed on the lower left region, and the fifth simulated cut and the sixth simulated cut are performed on the right region.

By the first simulated cut, the upper left region of the initial region set (3) is simulatively cut along the first data dimension to obtain a left sub-region and a right sub-region. Moreover, the cutting weight of the first simulated cut is calculated according to the data point numbers of the left sub-region and the right sub-region of the upper left region. By the second simulated cut, the upper left region of the initial region set (3) is simulatively cut along the second data dimension to obtain an upper sub-region and a lower sub-region. Moreover, the cutting weight of the second simulated cut is calculated according to the data point numbers of the upper sub-region and the lower sub-region of the upper left region. By the third simulated cut, the lower left region of the initial region set (3) is simulatively cut along the first data dimension to obtain a left sub-region and a right sub-region. Moreover, the cutting weight of the third simulated cut is calculated according to the data point numbers of the left sub-region and the right sub-region of the lower left region. By the fourth simulated cut, the lower left region of the initial region set (3) is simulatively cut along the second data dimension to obtain an upper sub-region and a lower sub-region. Moreover, the cutting weight of the fourth simulated cut is calculated according to the data point numbers of the upper sub-region and the lower sub-region of the lower left region. By the fifth simulated cut, the right region of the initial region set (3) is simulatively cut along the first data dimension to obtain a left sub-region and a right sub-region. Moreover, the cutting weight of the fifth simulated cut is calculated according to the data point numbers of the left sub-region and the right sub-region of the right region. By the sixth simulated cut, the right region of the initial region set (3) is simulatively cut along the second data dimension to obtain an upper sub-region and a lower sub-region. Moreover, the cutting weight of the sixth simulated cut is calculated according to the data point numbers of the upper sub-region and the lower sub-region of the right region. According to the cutting weights of these six simulated cuts, one of the six simulated cuts is determined as a selected cut. Then, a third cutting operation is performed on the data space according to the selected cut. The above procedures are repeatedly done. After an (N−1)-th cutting operation is performed on the data space, the data space has N regions. That is, the initial region set (N) with the N regions is the updated initial region set.

Please refer to the initial region set (N). The initial region set (N) contains N regions, the data point numbers of the N regions are known. Moreover, since two simulated cuts are performed on each region along two data dimensions, there are a total of 2N (i.e., N×2=2N) simulated cuts. Similarly, after one of the 2N simulated cuts is determined as a selected cut, an N-th cutting operation is performed on the data space according to the selected cut, so that the data space is further cut into (N+1) regions. That is, the initial region set (N+1) with the (N+1) regions is the updated initial region set. If the criterion of stopping the cutting operation is satisfied, the cutting process is ended.

FIG. 2B schematically illustrates a cutting process of performing a BSP algorithm in a three-dimensional data space. It is assumed that each data point contains three fields. The three fields are correlated with three data dimensions, respectively. That is, the data space may be represented as a three-dimensional space (i.e., data dimension d=3). In this context, the X-axis direction is defined as a first data dimension, the Y-axis direction is defined as a second data dimension, and the Z-axis direction is defined as a third data dimension. Moreover, after a massive number of raw data are normalized, plural data points (not shown) distributed over the two-dimensional data space are obtained. The normalized value of each data dimension is in the range between 0 and 1.

Please refer to the initial region set (1). The initial region set is the whole data space, and the data point number of the data space is known. Moreover, since the data space has only one region, there are a total of three simulated cuts along three data dimensions. According to the cutting weights of the three simulated cuts, one of the three simulated cuts is determined as a selected cut. For example, if the first simulated cut is determined as the selected cut, a first cutting operation along the first data dimension is performed on the data space. Under this circumstance, the initial region set (2) is the updated initial region set.

Please refer to the initial region set (2). The initial region set (2) contains two regions, and the data point numbers of the two regions are known. Moreover, since three simulated cuts are performed on each region along three data dimensions, there are a total of six (i.e., 2×3=6) simulated cuts. According to the cutting weights of the six simulated cuts, one of the six simulated cuts is determined as a selected cut. For example, if the first simulated cut is determined as the selected cut, a second cutting operation along the first data dimension is performed on the lower region of the data space. Under this circumstance, the initial region set (3) is the updated initial region set.

The above procedures are repeatedly done. After an (M−1)-th cutting operation is performed on the data space, the data space has M regions. That is, the initial region set (M) with the M regions is the updated initial region set. Please refer to the initial region set (M). The initial region set (M) contains M regions, the data point numbers of the M regions are known. Moreover, since three simulated cuts are performed on each region along three data dimensions, there are a total of 3M (i.e., M×3=3N) simulated cuts. Similarly, after one of the 3M simulated cuts is determined as a selected cut, an M-th cutting operation is performed on the data space according to the selected cut, and the data space has (M+1) regions. That is, the initial region set (M+1) with the (M+1) regions is the updated initial region set. If the criterion of stopping the cutting operation is satisfied, the cutting process is ended.

From the above descriptions, during the cutting process of the BSP algorithm, a simulated cut is performed on each region of the initial region set along each data dimension to generate two sub-regions, and the data point numbers of the two sub-regions for each simulated cut are calculated. Then, the cutting weight of each simulated cut is calculated according to the data point numbers of the two sub-regions for each simulated cut. After the cutting weights of all simulated cuts are obtained, a selected cut is determined according to the cutting weights. Generally, the simulated cut with the higher cutting weight has the higher probability to be determined as the selected cut.

FIG. 2C schematically illustrates a two-dimensional data space after a massive number of raw data are normalized. As shown in FIG. 2C, plural data points are distributed over the two-dimensional data space 200. These data points may be roughly classified into two groups, including an upper left group and a lower right group. Moreover, each black dot in the drawing denotes a data point. The normalized value of each data dimension is in the range between 0 and 1.

FIG. 2D schematically illustrates the result of plural cutting operations on the two-dimensional data space of FIG. 2C. In FIG. 2D, each line is correlated to a selected cut. After the cutting operations are repeatedly performed on the two-dimensional data space 200 according to the cutting process of the BSP algorithm, plural regions are generated. The simulated cut corresponding to the region with the higher data density has the higher probability to be determined as the selected cut. Please refer to FIG. 2D again. Increase of the line density implies increase of the concentration of the data points in the data space, and increase of the data density. In other words, the BSP algorithm is capable of effectively cutting the two-dimensional data space 200 and acquiring the data density. After the data density is acquired, the key information about the distribution of the data points can be further analyzed. However, as the number of cutting operations increases, the number of regions in the initial region set increases. Moreover, since the number of the simulated cuts increases, the process of calculating the data point numbers of the sub-regions is time-consuming.

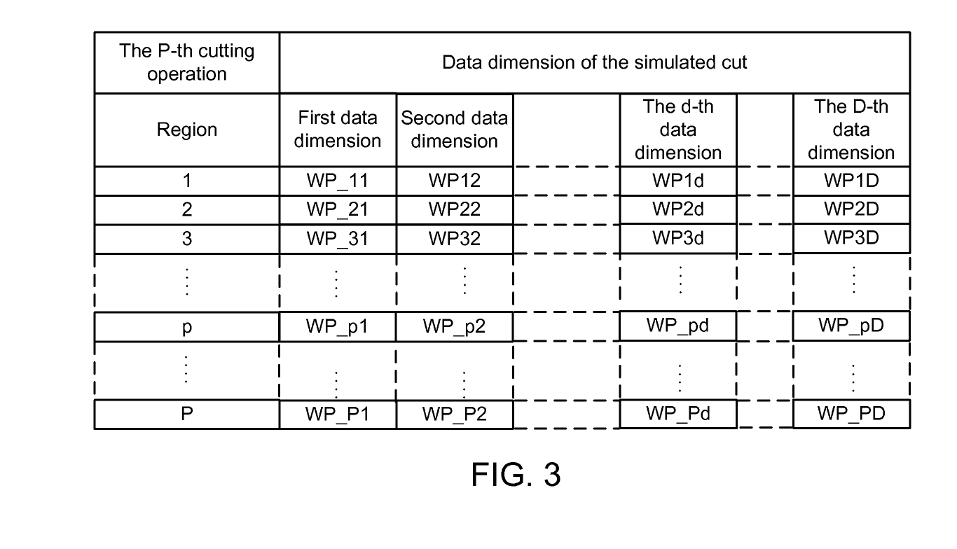

FIG. 3 is a flowchart illustrating a process of performing the P-th cutting operation on a D-dimensional data space. For example, the initial region set contains P regions, and the data point numbers of the P regions are known. Moreover, since D simulated cuts are performed on each region along D data dimensions, there are a total of (P×D) simulated cuts WP11˜WP_PD. After one of the (P×D) simulated cuts WP_11˜WP_PD is determined as a selected cut, the P-th cutting operation is performed on the data space. Consequently, the data space is cut into (P+1) regions. For calculating the (P×D) cutting weights, the data point numbers of (2×P×D) sub-regions should be acquired. The number of times for calculating the data point numbers of the sub-regions is correlated with the value P and the data dimension D. Moreover, as the value P increases, the number of times for calculating the data point numbers of the sub-regions increases. Therefore, it is important to effectively calculate the data point numbers of the sub-regions in order to reduce the burden of the BSP system in the multi-dimensional data space.

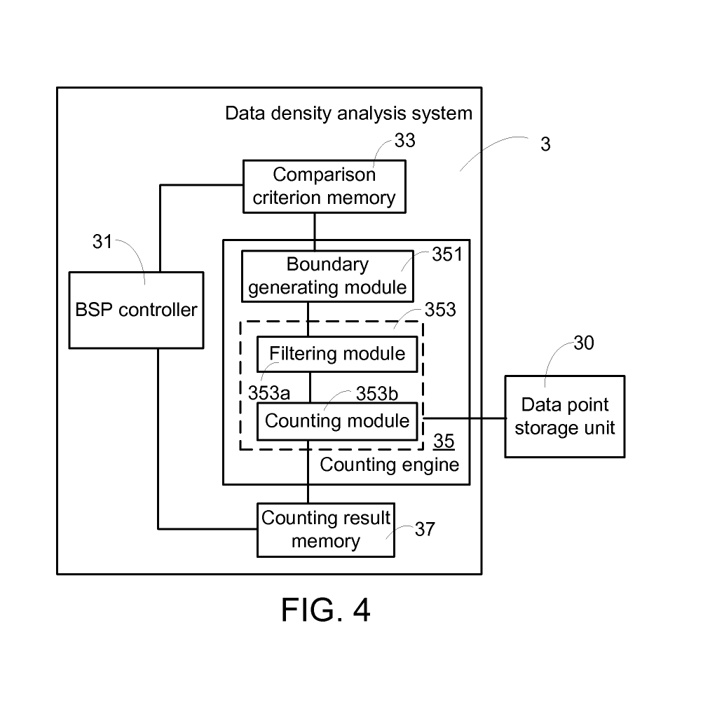

A Bayesian sequential partition system in a multi-dimensional data space will be illustrated as follows. FIG. 4 is a schematic functional block diagram illustrating a BSP system in a multi-dimensional data space according to an embodiment of the present invention. The BSP system 3 is a multi-dimensional data density analysis system. The multi-dimensional data density analysis system 3 includes a BSP controller 31, a comparison criterion memory 33, a counting engine 35 and a counting result memory 37. The counting engine 35 is electrically connected with the counting result memory 37. The counting engine 35 includes a boundary generating module 351, at least one filtering module 353a and at least one counting module 353b. The filtering module 353a and the corresponding counting module 353b are referred as a filtering and counting module 353.

The comparison criterion memory 33 is electrically connected with the BSP controller 31 and the boundary generating module 351. The BSP controller 31 generates a region information corresponding to a region of the data space. After being temporarily stored in the comparison criterion memory 33, the region information is transmitted to the boundary generating module 351. According to the region information, the boundary generating module 351 generates plural boundary information. According to the boundary information, the filtering module 353a determines whether the data points lie in a specified sub-region. The determining result of the filtering module 353a is transmitted to the counting module 353b. According to the determining result of the filtering module 353a, the counting module 353b counts a data point number of the specified sub-region (i.e., the sub-region counting result).

Moreover, the counting result memory 37 is electrically connected with the BSP controller 31 and the counting module 353b. The sub-region counting result generated by the counting module 353b is further transmitted to the BSP controller 31. Moreover, the dimension values of all data points along various data dimensions are stored in a data point storage unit 30. The dimension values of all data points along various data dimensions can be read out from the data point storage unit 30 by the filtering and counting module 353.

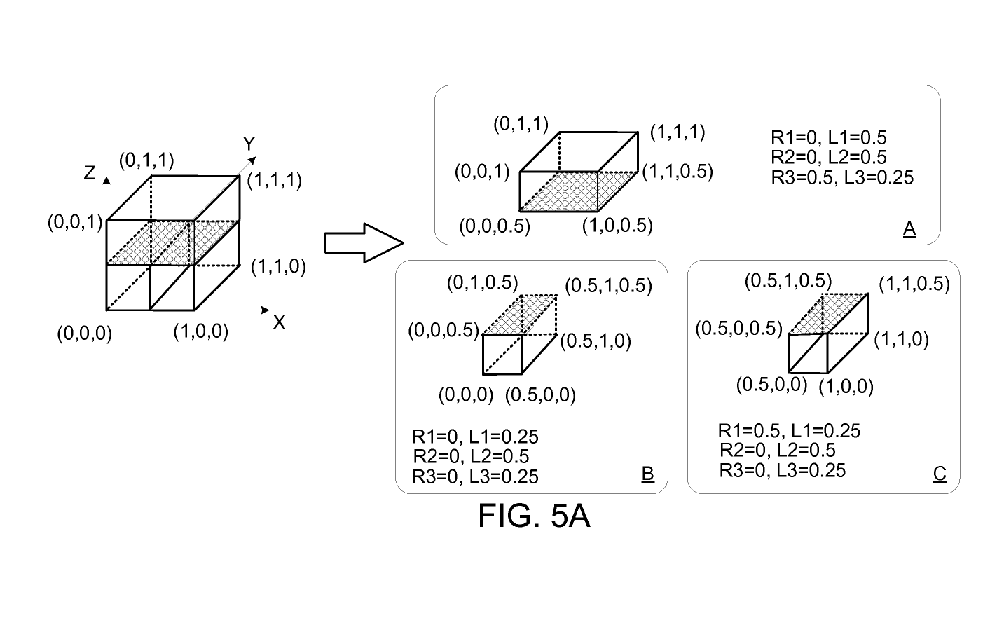

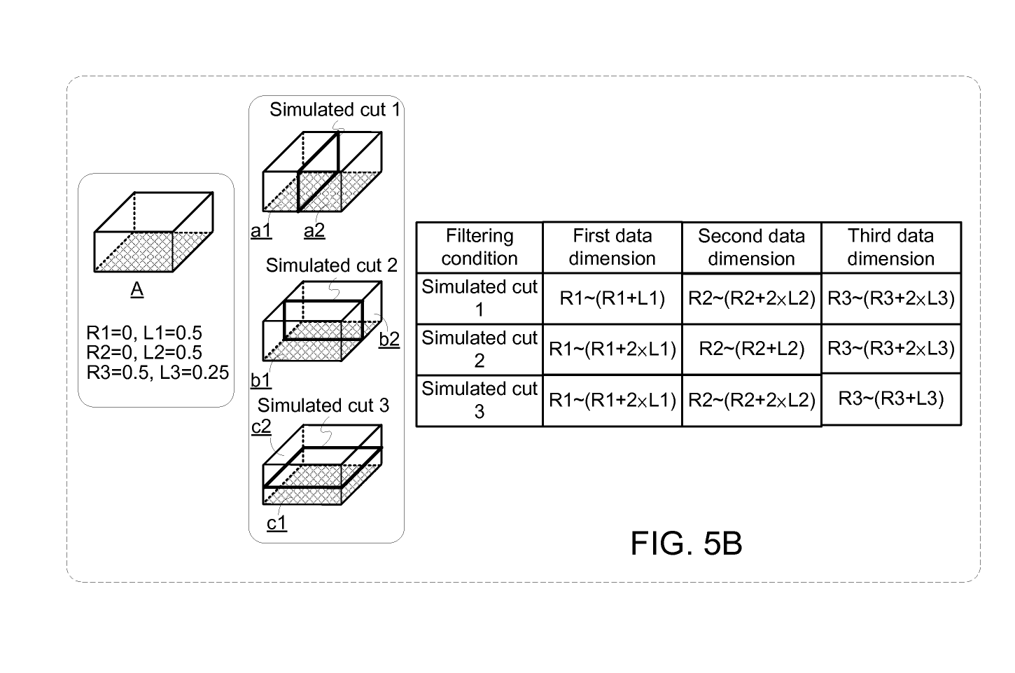

FIG. 5A schematically illustrates an initial region set in a three-dimensional data space. As shown in FIG. 5A, the initial region set contains three regions A, B and C. The data point numbers of these three regions are known. In a three-dimensional coordinate system with an X axis, a Y axis and a Z axis, each sub-region can be expressed by eight coordinates. Moreover, the present invention further provides a novel method of defining a region information of a region. That is, the three regions (A, B and C) of the initial region set may be expressed in simplified manner.

Please refer to FIG. 5A. The range of the region A along the first data dimension (e.g., the X-axis direction) is from 0 to 1; the range of the region A along the second data dimension (e.g., the Y-axis direction) is from 0 to 1; and the range of the region A along the third data dimension (e.g., the Z-axis direction) is from 0.5 to 1. That is, the component of the region A along the first data dimension starts from 0 and has a length of 1; the component of the region A along the second data dimension starts from 0 and has a length of 1; and the component of the region A along the third data dimension starts from 0.5 and has a length of 0.5. Consequently, the region information corresponding to the region A may be expressed as: (R1=0, L1=0.5), (R2=0, L2=0.5), (R3=0.5, L3=0.25), wherein R1, R2 and R3 are start points of components along the first, second and third data dimensions, and L1, L2 and L3 are half-lengths of the components along the first, second and third data dimensions. Similarly, the region information corresponding to the region B may be expressed as: (R1=0, L1=0.25), (R2=0, L2=0.5), (R3=0, L3=0.25). Similarly, the region information corresponding to the region C may be expressed as: (R1=0.5, L1=0.25), (R2=0, L2=0.5), (R3=0, L3=0.25).

FIG. 5B schematically illustrating the processes of performing various simulated cuts on the region A of the initial region set and the approach of calculating the data point number of the sub-regions. It is noted that the concepts can be applied to the region B and the region C of the initial region set. As mentioned above, the BSP algorithm can effectively cut the data space into plural regions by a sequential binary partitioning approach.

In the simulated cut 1, the region A is cut into a sub-region a1 and a sub-region a2 by a partitioning plane X=0.5 (i.e., X=R1+L1). In the simulated cut 2, the region A is cut into a sub-region b1 and a sub-region b2 by a partitioning plane Y=0.5 (i.e., Y=R2+L2). In the simulated cut 3, the region A is cut into a sub-region c1 and a sub-region c2 by a partitioning plane Z=0.75 (i.e., Z=R3+L3).

Through the simulated cut 1, the filtering condition of the sub-region a1 can be determined, and the data point number of the sub-region a1 can be calculated according to the filtering condition. Since the data point number of the region A is known, the data point number of the sub-region a2 can be obtained by subtracting the data point number of the sub-region a1 from the data point number of the region A. Similarly, through the simulated cut 2, the filtering condition of the sub-region b1 can be determined, and the data point numbers of the sub-regions b1 and b2 can be calculated accordingly. Similarly, through the simulated cut 3, the filtering condition of the sub-region c1 can be determined, and the data point numbers of the sub-regions c1 and c2 can be calculated accordingly.

According to the simulated cut 1, the filtering condition of the sub-region a1 includes: the filtering range R1˜(R1+L1) of the first data dimension, the filtering range R2˜(R2+2×L2) of the second data dimension and the filtering range R3˜(R3+2×L3) of the third data dimension. If the first dimension value, the second dimension value and the third dimension value of an under-test data point respectively lie within the filtering range R1˜(R1+L1) of the first data dimension, the filtering range R2˜(R2+2×L2) of the second data dimension and the filtering range R3˜(R3+2×L3) of the third data dimension, the under-test data point complies with the filtering condition of the simulated cut 1. Under this circumstance, the under-test data point is included in the sub-region a1. On the other hand, if the under-test data point does not comply with the filtering condition of the simulated cut 1, the under-test data point is not included in the sub-region a1.

According to the simulated cut 2, the filtering condition of the sub-region b1 includes: the filtering range R1˜(R1+2×L1) of the first data dimension, the filtering range R2˜(R2+L2) of the second data dimension and the filtering range R3˜(R3+2×L3) of the third data dimension. If the first dimension value, the second dimension value and the third dimension value of an under-test data point respectively lie within the filtering range R1˜(R1+2×L1) of the first data dimension, the filtering range R2˜(R2+L2) of the second data dimension and the filtering range R3˜(R3+2×L3) of the third data dimension, the under-test data point complies with the filtering condition of the simulated cut 2. Under this circumstance, the under-test data point is included in the sub-region b1. On the other hand, if the under-test data point does not comply with the filtering condition of the simulated cut 2, the under-test data point is not included in the sub-region b1.

According to the simulated cut 3, the filtering condition of the sub-region c1 includes: the filtering range R1˜(R1+2×L1) of the first data dimension, the filtering range R2˜(R2+2×L2) of the second data dimension and the filtering range R3˜(R3+L3) of the third data dimension. If the first dimension value, the second dimension value and the third dimension value of an under-test data point respectively lie within the filtering range R1˜(R1+2×L1) of the first data dimension, the filtering range R2˜(R2+2×L2) of the second data dimension and the filtering range R3˜(R3+L3) of the third data dimension, the under-test data point complies with the filtering condition of the simulated cut 3. Under this circumstance, the under-test data point is included in the sub-region c1. On the other hand, if the under-test data point does not comply with the filtering condition of the simulated cut 3, the under-test data point is not included in the sub-region c1.

In the multi-dimensional data density analysis system of FIG. 4, the BSP controller 31 generates the region information to the comparison criterion memory 33. According to the region information, the boundary generating module 351 generates the boundary information of all dimensions to the filtering and counting module 353. Based on the boundary information of each dimension, the filtering and counting module 353 establishes the filtering condition of each simulated cut and counts the data point number of the sub-region. The sub-region counting result is then stored in the counting result memory 37 and provided to the BSP controller 31.

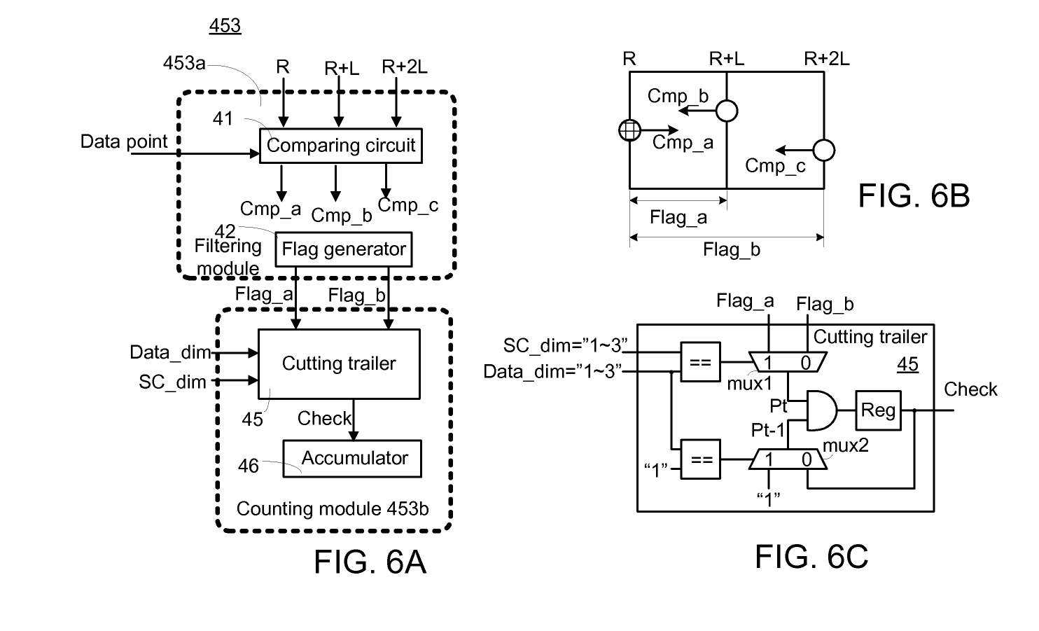

FIG. 6A is a schematic circuit diagram illustrating a first exemplary filtering and counting module used in the multi-dimensional data density analysis system of FIG. 4. As shown in FIG. 6A, the filtering and counting module 453 includes a filtering module 453a and a counting module 453b. The filtering module 453a at least includes a comparing circuit 41 and a flag generator 42. The counting module 453b at least includes a cutting trailer 45 and an accumulator 46. Moreover, in FIG. 6A, SC_dim indicates the data dimension of the simulated cut, Data_dim is an underway data dimension that is being processed, R is the start point of a single dimension of a region, and L is the half-length of a single dimension of a region. Consequently, the boundary information of the single dimension contain R, (R+L) and (R+2L).

FIG. 6B schematically illustrates the operations of the comparing circuit and the flag generator of FIG. 6A. The comparing circuit 41 includes at least three comparators for comparing the data point with the boundary information. The first comparator determines whether value of the data point is greater than or equal to R. If the data point is greater than or equal to R, the first comparing result Cmp_a is equal to “1” (i.e., Cmp_a=“1”). Whereas, if the data point is smaller than R, the first comparing result Cmp_a is equal to “0” (i.e., Cmp_a=“0”). The second comparator is determines whether the data point is smaller than (R+L). If the data point is smaller than (R+L), the second comparing result Cmp_b is equal to “1” (i.e., Cmp_b=“1”). Whereas, if the data point is greater than or equal to (R+L), the second comparing result Cmp_b is equal to “0” (i.e., Cmp_b=“0”). The third comparator determines whether the data point is smaller than (R+2L). If the data point is smaller than (R+2L), the third comparing result Cmp_c is equal to “1” (i.e., Cmp_c=“1”). Whereas, if the data point is greater than or equal to (R+2L), the third comparing result Cmp_c is equal to “0” (i.e., Cmp_c=“0”). Moreover, the flag generator 42 generates two flags according to the three comparing results of the comparing circuit 41. If the data point is in the range R˜(R+L), the first and the second comparing results Cmp_a and Cmp_b are both “1”, and the third comparing result Cmp_c is “0”. Under this circumstance, a first flag Flag_a is equal to “1” (i.e., Flag_a=“1”). If the data point is in the range R˜(R+2L), the first and the third comparing results Cmp_a and Cmp_c are both “1”, and the second comparing result Cmp_b is “0”. Under this circumstance, a second flag Flag_b is equal to “1” (i.e., Flag_b=“1”).

FIG. 6C is a schematic circuit diagram illustrating the cutting trailer of FIG. 6A. The cutting trailer 45 can establish the filtering range of each dimension and select one of the flag signals as the determining result. In particular, the cutting trailer 45 receives the flag signals from the flag generator 42 and selects one of the flag signals as the determining result according to SC_dim and Data_dim. As shown in FIG. 6C, the cutting trailer 45 includes a first multiplexer mux1, a second multiplexer mux2, an AND gate and a register Reg. If the data dimension SC_dim of the simulated cut and the underway data dimension Data_dim are identical, the first multiplexer mux1 selects the first flag Flag_a as a range signal Pt. Whereas, if the data dimension SC_dim of the simulated cut and the underway data dimension Data_dim are different, the first multiplexer mux1 selects the second flag Flag_b as the range signal Pt. Moreover, the data stored in the register Reg can be selected as a previous-stage region signal Pt-1 by the second multiplexer mux2. The range signal Pt and the previous-stage region signal Pt-1 are the inputs of the AND gate. The output of the AND gate is stored in the register Reg again. Moreover, if the underway data dimension Data_dim is the first dimension, the second multiplexer mux2 selects “1” as the previous-stage region signal Pt-1.

After the cutting trailer 45 generates the range signal Pt according to the data dimension SC_dim of the simulated cut and the underway data dimension Data_dim, the output of the AND gate is stored in the register Reg. According to the range signals of all data dimensions, the register Reg generates a result signal Check. If the result signal Check is equal to “1” (i.e., Check=“1”), the data point is included in a sub-region corresponding to the simulated cut. Whereas, if the result signal Check is equal to “0” (i.e., Check=“0”), the data point is not included in the sub-region corresponding to the simulated cut. Hereinafter, the operations of the filtering and counting module 453 will be illustrated in FIG. 5B.

While the filtering and counting module 453 counts the data point number of the sub-region al, the data dimension SC_dim of the simulated cut 1 is equal to 1 (i.e., SC_dim=“1”). Consequently, the following procedures are performed. Firstly, set the underway data dimension Data_dim=“1”, start point R=R1, and half-length L=L1. Moreover, the first multiplexer muxl selects the first flag Flag_a as the range signal Pt. In the step <A1>, the filtering module 453a determines whether the first dimension value of the first data point lies in the filtering range R1˜(R1+L1) of the first data dimension. If the first dimension value of the first data point lies in the filtering range R1˜(R1+L1), the cutting trailer 45 selects the first flag Flag_a=“1” as the range signal Pt and stores the range signal Pt in the register Reg. The range signal Pt may be considered as a result of determining whether the first dimension value of the first data point lies in the filtering range R1˜(R1+L1).

Next, set the underway data dimension Data_dim=“2”, start point R=R2, and half-length L=L2. Moreover, the first multiplexer muxl selects the second flag Flag_b as the range signal Pt. In the step <A2>, the filtering module 453a determines whether the second dimension value of the first data point lies in the filtering range R2˜(R2+2L2) of the second data dimension. If the second dimension value of the first data point lies in the filtering range R2˜(R2+2L2), the cutting trailer 45 selects the second flag Flag_b=“1” as the range signal Pt. Consequently, the range signal Pt and the previous-stage region signal Pt-1 are used as the inputs of the AND gate, and the output of the AND gate is stored in the register Reg. Meanwhile, the previous-stage region signal Pt-1 may be considered as a result of determining whether the first dimension value of the first data point lies in the filtering range R1˜(R1+L1), and the range signal Pt may be considered as a result of determining whether the second dimension value of the first data point lies in the filtering range R2˜(R2+2L2). Consequently, the output of the AND gate may be considered as the result of determining whether the first dimension value of the first data point lies in the filtering range R1˜(R1+L1) and the second dimension value of the first data point lies in the filtering range R2˜(R2+2L2).

Next, set the underway data dimension Data_dim=“3”, start point R=R3, and half-length L=L3. Moreover, the first multiplexer mux1 selects the second flag Flag_b as the range signal Pt. In the step <A3>, the filtering module 453a determines whether the third dimension value of the first data point lies in the filtering range R3˜(R3+2L3) of the third data dimension. If the third dimension value of the first data point lies in the filtering range R3˜(R3+2L3), the cutting trailer 45 selects the second flag Flag_b=“1” as the range signal Pt. Consequently, the range signal Pt and the previous-stage region signal Pt-1 are used as the inputs of the AND gate, and the output of the AND gate is stored in the register Reg. Meanwhile, the previous-stage region signal Pt-1 may be considered as a result of determining whether both the first dimension value and the second dimension value of the first data point are in the filtering ranges, and the range signal Pt may be considered as a result of determining whether the third dimension value of the first data point lies in the filtering range R3˜(R3+2L3). Consequently, the output of the AND gate may be considered as the result of determining whether the first dimension value of the first data point lies in the filtering range R1˜(R1+L1), the second dimension value of the first data point lies in the filtering range R2˜(R2+2L2) and the third dimension value of the first data point lies in the filtering range R3˜(R3+2L3).

In the above steps <A1>, <A2> and <A3>, the filtering conditions are established according to the data dimension SC_dim of the simulated cut 1 (i.e., SC_dim=“1”). Moreover, according to the change of the underway data dimension Data_dim, three filtering ranges are sequentially generated. Moreover, the final range signal Pt stored in the register Reg is “1” only if the three range signals Pt obtained according to the three filtering ranges are all “1”. Under this circumstance, it is ascertained that the first data point is included in the sub-region a1. Consequently, the result signal Check=“1” and the counting value in the accumulator 46 is added by 1. On the other hand, if the final range signal Pt stored in the register Reg is “0”, it is ascertained that the first data point is not included in the sub-region a1. Consequently, the result signal Check=“0” and the counting value in the accumulator 46 is kept unchanged. In case that the data point number of the data space is equal to M_data, after the procedure of the steps <A1>, <A2> and <A3> should be performed for M_data times, the counting value in the accumulator 46 is the data point number of the sub-region a1.

While the filtering and counting module 453 counts the data point number of the sub-region b1, the data dimension SC_dim of the simulated cut 2 is equal to 2 (i.e., SC_dim=“2”). Consequently, the following procedures are performed. Firstly, set the underway data dimension Data_dim=“1”, start point R=R1, and half-length L=L1. Moreover, the first multiplexer mux1 selects the second flag Flag_b as the range signal Pt. In the step <B1>, the filtering module 453a determines whether the first dimension value of the first data point lies in the filtering range R1˜(R1+2L1) of the first data dimension. If the first dimension value of the first data point lies in the filtering range R1˜(R1+2L1), the cutting trailer 45 selects the second flag Flag_b=“1” as the range signal Pt and stores the range signal Pt in the register Reg. The range signal Pt may be considered as a result of determining whether the first dimension value of the first data point lies in the filtering range R1˜(R1+2L1).

Next, set the underway data dimension Data_dim=“2”, start point R=R2, and half-length L=L2. Moreover, the first multiplexer muxl selects the first flag Flag_a as the range signal Pt. In the step <B2>, the filtering module 453a determines whether the second dimension value of the first data point lies in the filtering range R2˜(R2+L2) of the second data dimension. If the second dimension value of the first data point lies in the filtering range R2˜(R2+L2), the cutting trailer 45 selects the first flag Flag_a=“1” as the range signal Pt. Consequently, the range signal Pt and the previous-stage region signal Pt-1 are used as the inputs of the AND gate, and the output of the AND gate is stored in the register Reg. Meanwhile, the previous-stage region signal Pt-1 may be considered as a result of determining whether the first dimension value of the first data point lies in the filtering range R1˜(R1+2L1), and the range signal Pt may be considered as a result of determining whether the second dimension value of the first data point lies in the filtering range R2˜(R2+L2). Consequently, the output of the AND gate may be considered as the result of determining whether the first dimension value of the first data point lies in the filtering range R1˜(R1+2L1) and the second dimension value of the first data point lies in the filtering range R2˜(R2+L2).

Next, set the underway data dimension Data_dim=“3”, start point R=R3, and half-length L=L3. Moreover, the first multiplexer mux1 selects the second flag Flag_b as the range signal Pt. In the step <B3>, the filtering module 453a determines whether the third dimension value of the first data point lies in the filtering range R3—(R3+2L3) of the third data dimension. If the third dimension value of the first data point lies in the filtering range R3˜(R3+2L3), the cutting trailer 45 selects the second flag Flag_b=“1” as the range signal Pt. Consequently, the range signal Pt and the previous-stage region signal Pt-1 are used as the inputs of the AND gate, and the output of the AND gate is stored in the register Reg. Meanwhile, the previous-stage region signal Pt-1 may be considered as a result of determining whether the first dimension value and the second dimension value of the first data point are in the filtering ranges, and the range signal Pt may be considered as a result of determining whether the third dimension value of the first data point lies in the filtering range R3˜(R3+2L3). Consequently, the output of the AND gate may be considered as the result of determining whether the first dimension value of the first data point lies in the filtering range R1˜(R1+2L1), the second dimension value of the first data point lies in the filtering range R2˜(R2+L2) and the third dimension value of the first data point lies in the filtering range R3˜(R3+2L3).

In the above steps <B1>, <B2> and <B3>, the filtering conditions are established according to the data dimension SC_dim of the simulated cut 2 (i.e., SC_dim=“2”). Moreover, according to the change of the underway data dimension Data_dim, three filtering ranges are sequentially generated. Moreover, the final range signal Pt stored in the register Reg is “1” only if the three range signals Pt obtained according to the three filtering ranges are all “1”. Under this circumstance, it is ascertained that the first data point is included in the sub-region b1. Consequently, the result signal Check=“1” and the counting value in the accumulator 46 is added by 1. On the other hand, if the final range signal Pt stored in the register Reg is “0”, it is ascertained that the first data point is not included in the sub-region b1. Consequently, the result signal Check=“0” and the counting value in the accumulator 46 is kept unchanged. In case that the data point number of the data space is equal to M_data, after the procedure of the steps <B1>, <B2> and <B3> should be performed for M_data times, the counting value in the accumulator 46 is the data point number of the sub-region b1.

While the filtering and counting module 453 counts the data point number of the sub-region c1, the data dimension SC_dim of the simulated cut 3 is equal to 3 (i.e., SC_dim=“3”). Consequently, the following procedures are performed. Firstly, set the underway data dimension Data_dim=“1”, start point R=R1, and half-length L=L1. Moreover, the first multiplexer mux1 selects the second flag Flag_b as the range signal Pt. In the step <C1>, the filtering module 453a determines whether the first dimension value of the first data point lies in the filtering range R1˜(R1+2L1) of the first data dimension. If the first dimension value of the first data point lies in the filtering range R1˜(R1+2L1), the cutting trailer 45 selects the second flag Flag_b=“1” as the range signal Pt and stores the range signal Pt in the register Reg. The range signal Pt may be considered as a result of determining whether the first dimension value of the first data point lies in the filtering range R1˜(R1+2L1).

Next, set the underway data dimension Data_dim=“2”, start point R=R2, and half-length L=L2. Moreover, the first multiplexer mux1 selects the second flag Flag_b as the range signal Pt. In the step <C2>, the filtering module 453a determines whether the second dimension value of the first data point lies in the filtering range R2˜(R2+2L2) of the second data dimension. If the second dimension value of the first data point lies in the filtering range R2˜(R2+2L2), the cutting trailer 45 selects the second flag Flag_b=“1” as the range signal Pt. Consequently, the range signal Pt and the previous-stage region signal Pt-1 are used as the inputs of the AND gate, and the output of the AND gate is stored in the register Reg. Meanwhile, the previous-stage region signal Pt-1 may be considered as a result of determining whether the first dimension value of the first data point lies in the filtering range R1˜(R1+2L1), and the range signal Pt may be considered as a result of determining whether the second dimension value of the first data point lies in the filtering range R2˜(R2+2L2). Consequently, the output of the AND gate may be considered as the result of determining whether the first dimension value of the first data point lies in the filtering range R1˜(R1+2L1) and the second dimension value of the first data point lies in the filtering range R2˜(R2+2L2).

Next, set the underway data dimension Data_dim=“3”, start point R=R3, and half-length L=L3. Moreover, the first multiplexer mux1 selects the first flag Flag_a as the range signal Pt. In the step <C3>, the filtering module 453a determines whether the third dimension value of the first data point lies in the filtering range R3˜(R3+L3) of the third data dimension. If the third dimension value of the first data point lies in the filtering range R3˜(R3+L3), the cutting trailer 45 selects the first flag Flag_a as the range signal Pt. Consequently, the range signal Pt and the previous-stage region signal Pt-1 are used as the inputs of the AND gate, and the output of the AND gate is stored in the register Reg. Meanwhile, the previous-stage region signal Pt-1 may be considered as a result of determining whether the first dimension value and the second dimension value of the first data point are in the filtering ranges, and the range signal Pt may be considered as a result of determining whether the third dimension value of the first data point lies in the filtering range R3˜(R3+L3). Consequently, the output of the AND gate may be considered as the result of determining whether the first dimension value of the first data point lies in the filtering range R1˜(R1+2L1), the second dimension value of the first data point lies in the filtering range R2˜(R2+2L2) and the third dimension value of the first data point lies in the filtering range R3˜(R3+L3).

In the above steps <C1>, <C2> and <C3>, the filtering conditions are established according to the data dimension SC_dim of the simulated cut 3 (i.e., SC_dim=“3”). Moreover, according to the change of the underway data dimension Data_dim, three filtering ranges are sequentially generated. Moreover, the final range signal Pt stored in the register Reg is “1” only if the three range signals Pt obtained according to the three filtering ranges are all “1”. Under this circumstance, it is ascertained that the first data point is included in the sub-region c1. Consequently, the result signal Check=“1” and the counting value in the accumulator 46 is added by 1. On the other hand, if the final range signal Pt stored in the register Reg is “0”, it is ascertained that the first data point is not included in the sub-region c1. Consequently, the result signal Check=“0” and the counting value in the accumulator 46 is kept unchanged. In case that the data point number of the data space is equal to M_ata, after the procedure of the steps <C1>, <C2> and <C3> should be performed for M_data times, the counting value in the accumulator 46 is the data point number of the sub-region c1.

From the above descriptions, the procedure of the steps <A1>, <A2> and <A3> should be performed for M_data times in order to acquire the data point number of the sub-region a1, the procedure of the steps <B1>, <B2> and <B3> should be performed for M_data times in order to acquire the data point number of the sub-region b1, and the procedure of the steps <C1>, <C2> and <C3> should be performed for M_data times in order to acquire the data point number of the sub-region c1. Since the procedure of the steps <A1>, <A2> and <A3>, the procedure of the steps <B1>, <B2> and <B3> and the procedure of the steps <C1>, <C2> and <C3> are similar, the filtering and counting module may be modified so as to reduce the filtering and counting time duration.

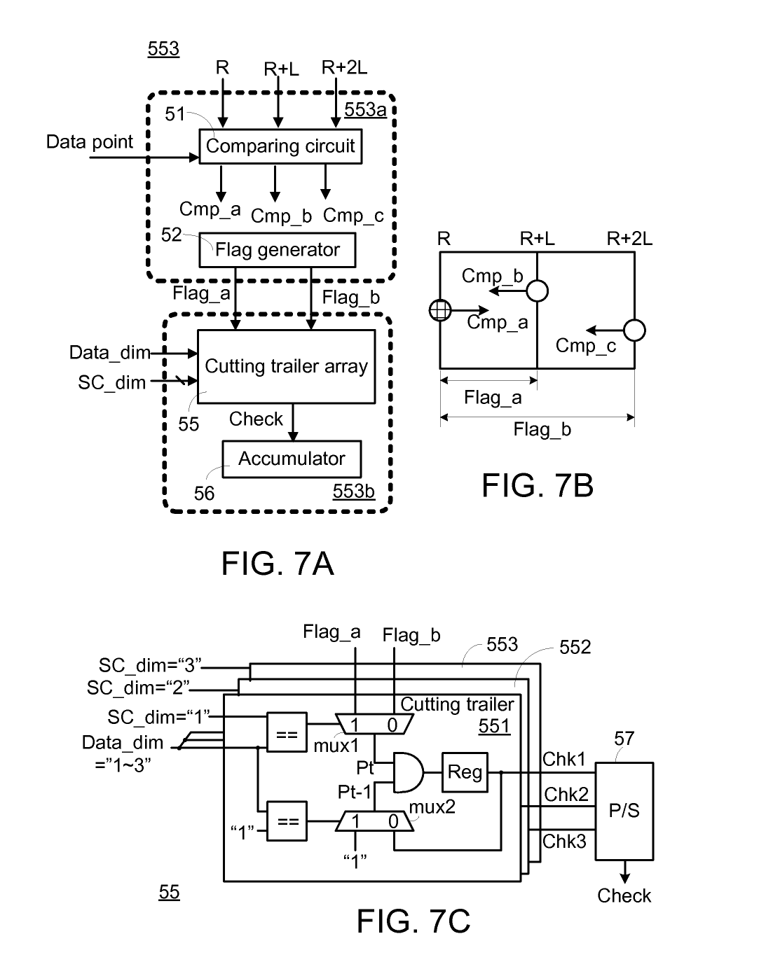

FIG. 7A is a schematic circuit diagram illustrating a second exemplary filtering and counting module of FIG. 4. As shown in FIG. 7A, the filtering and counting module 553 includes a filtering module 553a and a counting module 553b. The filtering module 553a at least includes a comparing circuit 51 and a flag generator 52. The counting module 553b at least includes a cutting trailer array 55 and an accumulator 56. Moreover, in FIG. 7A, SC_dim indicates the data dimension of the simulated cut, Data_dim is an underway data dimension that is being processed, R is the start point of a single dimension of a region, and L is the half-length of a single dimension of a region. Consequently, the boundary information of the single dimension contain R, (R+L) and (R+2L). In comparison with the counting module 453b of FIG. 6A, the counting module 553b of this embodiment includes the cutting trailer array 55 in replace of the cutting trailer 45. FIG. 7B schematically illustrates the operations of the comparing circuit and the flag generator of the filtering and counting module of FIG. 7A. The operations of the comparing circuit 51 and the flag generator 52 of FIG. 7B are similar to those of FIG. 6B, and are not redundantly described herein.

FIG. 7C is a schematic circuit diagram illustrating the cutting trailer array of FIG. 7A. The cutting trailer array 55 can establish the filtering range of each dimension and select one of the flag signals as the determining result. In particular, the cutting trailer array 55 receives the flag signals Flag_a and Flag_b from the flag generator 52 and selects one of the flag signals as the determining result according to SC_dim and Data_dim. As shown in FIG. 7C, the cutting trailer array 55 includes three cutting trailers 551, 552, 553 and a parallel to serial circuit (P/S) 57. The configurations of each of the three cutting trailers 551, 552 and 553 are similar to those of the cutting trailer 45 of FIG. 6C, and are not redundantly described herein. The cutting trailer 551 is used to process the first dimension of the simulated cut 1, so that SC_dim=“1” is inputted into the cutting trailer 551. The cutting trailer 551 is used to process the second dimension of the simulated cut 2, so that SC_dim=“2” is inputted into the cutting trailer 552. The cutting trailer 553 is used to process the third dimension of the simulated cut 3, so that SC_dim=“3” is inputted into the cutting trailer 553.

After the first data point is inputted into the filtering module 553a and the procedures of determining whether the three dimension values of the first data point lie in the three filtering ranges are performed, three result signals Chk1, Chk2 and Chk3 are outputted from the counting module 553b. According to the result signals Chk1, Chk2 and Chk3, the filtering and counting module 553 can realize whether the first data point is included in the sub-regions a1, b1 and c1. Then, the result signals Chk1, Chk2 and Chk3 are converted into a serial result signal Check by the parallel to serial circuit 57. After the serial result signal Check is transmitted to the accumulator 56, the counting values in the accumulator 56 corresponding to the sub-regions a1, b1 and c1 are accumulated.

In case that the data point number of the data space is equal to M_data, after the above procedures are performed for M_data times, the counting values in the accumulator 56 are the data point numbers of the sub-region a1, b1 and c1. In comparison with the filtering and counting module 453 of FIG. 6A, the filtering and counting module 553 of this embodiment can acquire the data point numbers of all sub-regions of the region while shortening the counting time.

Please refer to FIG. 5A again. The region B and the region C may be determined according to the previous selected cut on the initial region set. The filtering range of region B along the first dimension and the filtering range of region C along the first dimension are distinguished. However, the filtering ranges of region B along the second and third dimensions and the filtering ranges of region C along the second and third dimensions are identical. Consequently, the region B and the region C are symmetrical to each other. Under this circumstance, the region B may be referred as an input region, and the region C may be referred as a symmetric region.

In other word, at least two regions of an initial region set are symmetrical to each other. The two regions which are symmetrical to each other are determined according to the previous selected cut. The boundaries of data dimension of the input region and the symmetric region corresponding to the previous selected cut are symmetrical to each other. However, the boundaries of the input region and the boundaries of the symmetric region along other data dimensions are identical. As mentioned, the BSP controller 31 generates a region information corresponding to a specified region of the data space, and the region information is stored in the comparison criterion memory 33. In an embodiment, the specified region is the input region. Under this circumstance, the boundary generating module 351 can simultaneously generate the boundary information of both the input region and the symmetric region. Consequently, the filtering and counting module may be modified so as to increase the processing speed.

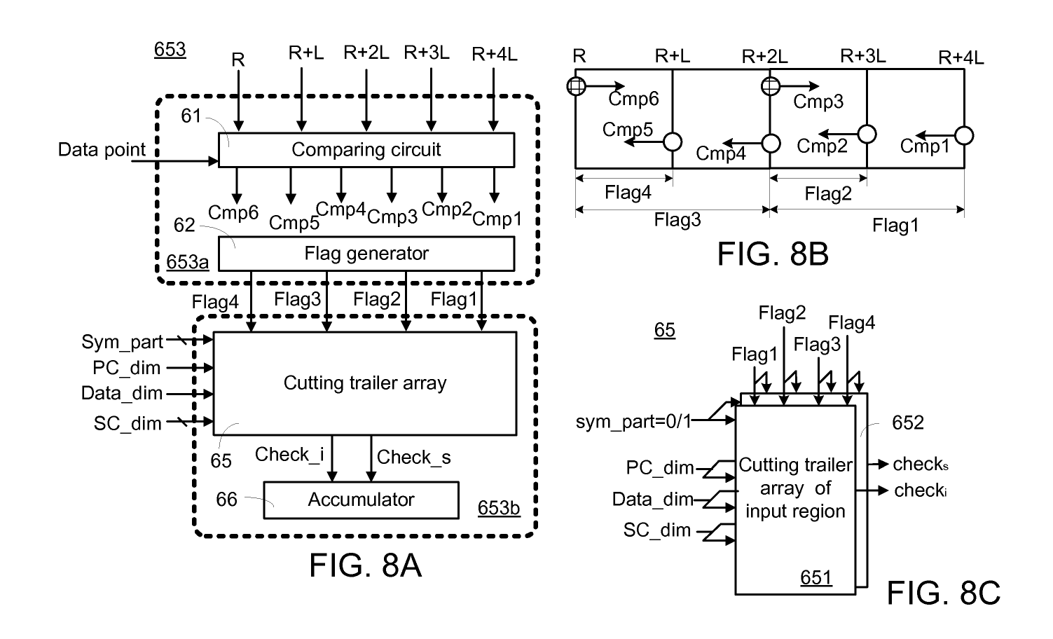

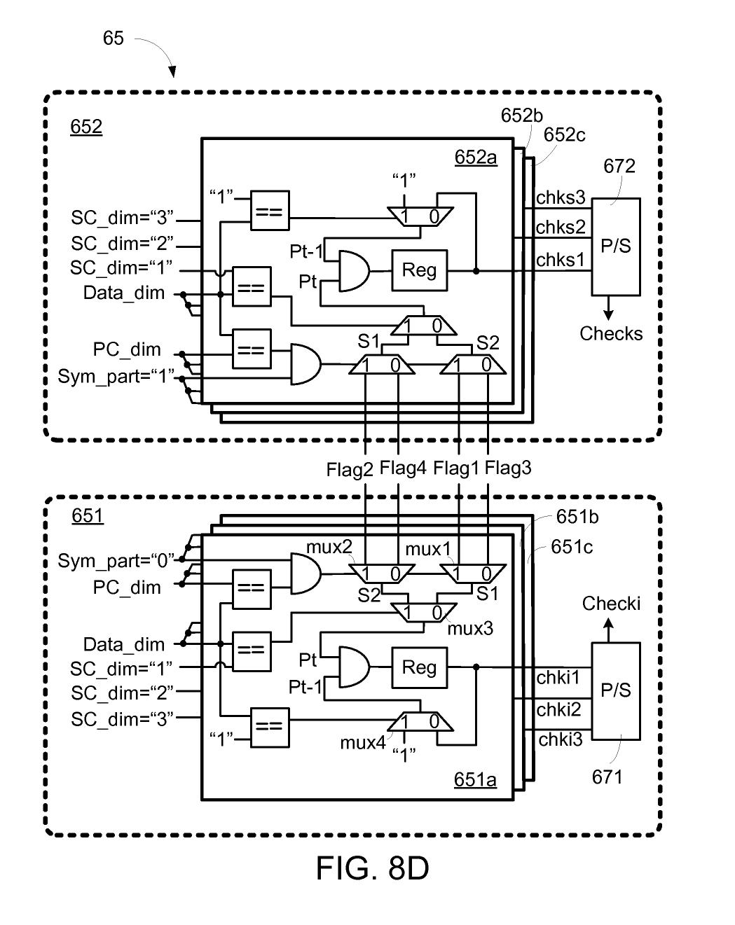

FIG. 8A is a schematic circuit diagram illustrating a third exemplary filtering and counting module of FIG. 4. As shown in FIG. 8A, the filtering and counting module 653 includes a filtering module 653a and a counting module 653b. The filtering module 653a at least includes a comparing circuit 61 and a flag generator 62. The counting module 653b at least includes a cutting trailer array 65 and an accumulator 66. Moreover, in FIG. 8A, SC_dim indicates the data dimension of the simulated cut, Data_dim is an underway data dimension that is being processed, PC_dim is the data dimension of the previous selected cut, Sym_part is a symmetric part indication signal, R is the start point of a single dimension of a region, and L is the half-length of a single dimension of a region. Consequently, the boundary information of the single dimension of the input region and the symmetric region contain R, (R+L), (R+2L), (R+3L) and (R+4L).

FIG. 8B schematically illustrates the operations of the comparing circuit and the flag generator of FIG. 8A. The comparing circuit 61 includes six comparators for comparing the data point with the boundary information. The first comparator determines whether the data point is smaller than (R+4L). If so, the first comparing result Cmp1 is equal to “1” (Cmp1=“1”). Whereas, if the data point is greater than or equal to (R+4L), the first comparing result is equal to “0” (Cmp1=“0”). The second comparator determines whether the data point is smaller than (R+3L). If so, the second comparing result is equal to “1” (Cmp2=“1”). Whereas, if the data point is greater than or equal to (R+3L), the second comparing result Cmp2 is equal to “0” (Cmp2=“0”). The third comparator determines whether the data point is greater than or equal to (R+2L). If so, the third comparing result Cmp3 is equal to “1” (Cmp3=“1”). Whereas, if the data point is smaller than (R+2L), the third comparing result Cmp3 is equal to “0” (Cmp3=“0”). The fourth comparator determines whether the data point is smaller than (R+2L). If so, the fourth comparing result Cmp4 is equal to “1” (Cmp4=“1”). Whereas, if the data point is greater than or equal to (R+2L), the fourth comparing result Cmp4 is equal to “0” (Cmp4=“0”). The fifth comparator determines whether the data point is smaller than (R+L). If so, the fifth comparing result Cmp5 is equal to “1” (Cmp5=“1”). Whereas, if the data point is greater than or equal to (R+L), the fifth comparing result Cmp5 is equal to “0” (Cmp5=“0”). The sixth comparator determines whether the data point is greater than or equal to R. If so, the sixth comparing result Cmp6 is equal to “1” (Cmp6=“1”). Whereas, if the data point is smaller than R, the sixth comparing result Cmp6 is equal to “1” (Cmp6=“0”). Moreover, the flag generator 62 generates four flags according to the six comparing results of the comparing circuit 61. If the data point is in the range R˜(R+L), the comparing results Cmp6 and Cmp5 are both “1” and thus a fourth flag Flag4 is equal to “1” (Flag4=“1”). If the data point is in the range R˜(R+2L), the comparing results Cmp6 and Cmp4 are both “1” and thus a third flag Flag3 is equal to “1” (Flag3=“1”). If the data point is in the range (R+2L)˜(R+3L), the comparing results Cmp3 and Cmp2 are both “1” and thus a second flag Flag2 is equal to “1” (Flag2=“1”). If the data point is in the range (R+2L)˜(R+4L), the comparing results Cmp3 and Cmp1 are both “1” and thus a first flag Flag1 is equal to “1” (Flag1=“1”).

FIG. 8C is a schematic circuit diagram illustrating the cutting trailer array of FIG. 8A. The cutting trailer array 65 can establish the filtering range of each dimension of the input region and the symmetric region and select one of the flag signals as the determining result. The cutting trailer array 65 includes a cutting trailer array 651 of the input region and a cutting trailer array 652 of the symmetric region. Moreover, the cutting trailer array 65 receives the data dimension SC_dim of the simulated cut, the underway data dimension Data_dim, the data dimension PC_dim of the previous selected cut, the symmetric part indication signal Sym_part and the four flag signals Flag1˜Flag4.

FIG. 8D is a schematic circuit diagram illustrating the cutting trailer array of FIG. 8C. For example, the data space is a three-dimensional data space. The cutting trailer array 65 includes six cutting trailers 651a, 651b, 651c, 652a, 652b and 652c. The configurations of these six cutting trailers are identical, but the input signals of these six cutting trailers are not completely identical. In case that the symmetric part indication signal Sym_part is equal to “0” (Sym_part=“0”), the input region is processed by the corresponding cutting trailers. Whereas, in case that the symmetric part indication signal Sym_part is equal to “1” (Sym_part=“1”), the symmetric region is processed by the corresponding cutting trailers. The three cutting trailers 652a, 652b and 652c are collaboratively defined as the cutting trailer array 652 of the symmetric region for determining whether the data point is in the sub-region of the symmetric region. The three cutting trailers 651a, 651b and 651c are collaboratively defined as the cutting trailer array 651 of the input region for determining whether the data point is in the sub-region of the input region. Since the configurations of the six cutting trailers are identical, the cutting trailer 651 a will be illustrated as an example.

In case that the symmetric part indication signal Sym_part is equal to “0” (Sym_part=“0”), regardless of whether the underway data dimension Data_dim and the data dimension PC_dim of the previous selected cut are identical, the first multiplexer mux1 selects the third flag Flag3 as a first signal S1, and the second multiplexer mux2 selects the fourth flag Flag4 as a second signal S2. If the data dimension SC_dim of the simulated cut and the underway data dimension Data_dim are identical, a third multiplexer mux3 selects the second signal S2 (i.e., the fourth flag Flag4) as a range signal Pt. Whereas, if the data dimension SC_dim of the simulated cut and the underway data dimension Data_dim are different, the third multiplexer mux3 selects the first signal S1 (i.e., the third flag Flag3) as the range signal Pt.

In case that the symmetric part indication signal Sym_part is equal to “1” (Sym_part=“1”), the outputs of the first multiplexer mux1 and the second multiplexer mux2 are determined according to the relationship between the underway data dimension Data_dim and the data dimension PC_dim of the previous selected cut. If the underway data dimension Data_dim and the data dimension PC_dim of the previous selected cut are identical, the first multiplexer mux1 selects the first flag Flag1 as the first signal S1, and the second multiplexer mux2 selects the second flag Flag2 as the second signal S2. On the other hand, if the underway data dimension Data_dim and the data dimension PC_dim of the previous selected cut are different, the first multiplexer mux1 selects the third flag Flag3 as the firs signal S1, and the second multiplexer mux2 selects the fourth flag Flag4 as the second signal S2.

If the data dimension SC_dim of the simulated cut and the underway data dimension Data_dim are identical, a third multiplexer mux3 selects the second signal S2 (i.e., the second flag Flag2 or the fourth flag Flag4) as a range signal Pt. Whereas, if the data dimension SC_dim of the simulated cut and the underway data dimension Data_dim are different, the third multiplexer mux3 selects the first signal S1 (i.e., the first flag Flag1 or the third flag Flag3) as the range signal Pt. Moreover, the data stored in the register Reg is selected as a previous-stage region signal Pt-1 by a fourth multiplexer mux4. The range signal Pt and the previous-stage region signal Pt-1 are the inputs of the AND gate, and the output of the AND gate is stored in the register Reg again. Moreover, if the underway data dimension Data_dim is the first dimension, the fourth multiplexer mux4 selects “1” as the previous-stage region signal Pt-1.

After the cutting trailer array 651 of the input region generates the range signal Pt according to the data dimension SC_dim of the simulated cut and the underway data dimension Data_dim, the output of the AND gate is stored in the register Reg. According to the range signals of all data dimensions, the register Reg generates a result signal Chki1. If the result signal Chki1 is equal to “1” (Chki1=“1”), the data point is included in a sub-region corresponding to the simulated cut of the input region. Whereas, if the result signal Chki1 is equal to “0” (Chki1=“0”), the data point is not included in a sub-region corresponding to the simulated cut of the input region.

The cutting trailer 651a is used to process the first dimension of the simulated cut 1 of the input region, so that SC_dim=“1” is inputted into the cutting trailer 65a. The cutting trailer 651b is used to process the second dimension of the simulated cut 2 of the input region, so that SC_dim=“2” is inputted into the cutting trailer 651b. The cutting trailer 651c is used to process the third dimension of the simulated cut 3 of the input region, so that SC_dim=“3” is inputted into the cutting trailer 651c. The cutting trailer 652a is used to process the first dimension of the simulated cut 1 of the symmetric region, so that SC_dim=“1” is inputted into the cutting trailer 65a. The cutting trailer 652b is used to process the second dimension of the simulated cut 2 of the symmetric region, so that SC_dim=“2” is inputted into the cutting trailer 652b. The cutting trailer 652c is used to process the third dimension of the simulated cut 3 of the symmetric region, so that SC_dim=“3” is inputted into the cutting trailer 652c.

After the first data point is inputted into the comparing circuit 61 and the procedures of determining whether the three dimension values of the first data point lie in the three filtering ranges are performed, three result signals Chki1, Chki2 and Chki3 are outputted from the cutting trailers 651a, 651b and 651c, respectively. According to the three result signals Chki1, Chki2 and Chki3, the filtering and counting module 653 can realize whether the first data point is included in the three sub-regions of the input region. Similarly, according to the three result signals Chks1, Chks2 and Chks3 from the cutting trailers 652a, 652b and 652c, the filtering and counting module 653 can realize whether the first data point is included in the three sub-regions of the symmetric region. Moreover, the result signals Chki1, Chki2 and Chki3 are converted into a serial result signal Checki by the parallel to serial circuit 671. After the serial result signal Checki is transmitted to the accumulator 66, the counting values in the accumulator 66 corresponding to the sub-regions of the input region are accumulated. Similarly, the result signals Chks1, Chks2 and Chks3 are converted into a serial result signal Checks by the parallel to serial circuit 672. After the serial result signal Checks is transmitted to the accumulator 66, the counting values in the accumulator 66 corresponding to the sub-regions of the symmetric region are accumulated. The counting results of the data point numbers of the sub-regions of the input region and the symmetric region are stored in the counting result memory. The current counting value corresponding to the specified sub-region is read out from the counting result memory. If the result signal corresponding to a specified sub-region is “1”, the current counting value corresponding to the specified sub-region is accumulated by the accumulator 66, and the updated counting value is stored back to the counting result memory.

In case that the data point number of the data space is equal to M_data, after the above procedures are performed for M_data times, the counting values in the accumulator 66 contain the data point numbers of the three sub-regions of the input region and the data point numbers of the three sub-regions of the symmetric region. In comparison with the filtering and counting module 553 of FIG. 7A, the filtering and counting module 653 of this embodiment can acquire the data point numbers of all sub-regions of the region while shortening the counting time.

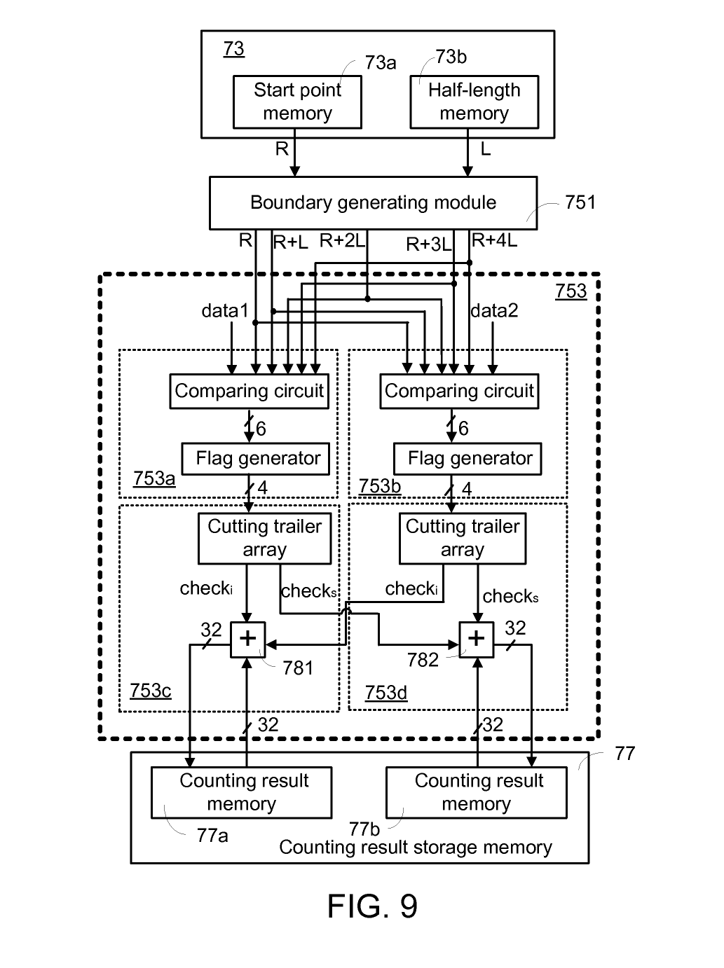

In accordance with the present invention, the Bayesian sequential partition system further includes a parallel processing mechanism for simultaneously determining whether two data points are included in the sub-region. For implementing the parallel processing mechanism, the executing speed of the filtering and counting module is further enhanced. FIG. 9 is a schematic functional block diagram illustrating a BSP system in a multi-dimensional data space according to another embodiment of the present invention. In this embodiment, the BSP system includes a BSP controller, a comparison criterion memory 73, a boundary generating module 751, a filtering and counting module 753 and a counting result storage memory 77. For brevity, the BSP controller is not shown in FIG. 9. However, the architecture of the BSP system of FIG. 9 is substantially similar to the architecture of the BSP system of FIG. 4.

The comparison criterion memory 73 includes a start point memory 73a and a half-length memory 73b. The start point memory 73a is used for storing the start point R from the BSP controller. The half-length memory 73b is used for storing the half-length L from the BSP controller. The counting result storage memory 77 includes two counting result memories 77a and 77b. The counting result corresponding to the input region is stored in the counting result memory 77a. The counting result corresponding to the symmetric region is stored in the counting result memory 77b. The boundary generating module 751 is electrically connected with the comparison criterion memory 73 and the filtering and counting module 753. The filtering and counting module 753 is also electrically connected with the counting result storage memory 77. The boundary generating module 751 can acquire the region information R and the region information L. According to the region information R and the region information L, the boundary generating module 751 generates the boundary information of each dimension to the filtering and counting module 753. The boundary information of each dimension contain R, (R+L), (R+2L), (R+3L) and (R+4L).

The filtering and counting module 753 includes two filtering modules 753a, 753b and two counting modules 753c, 753d. The operations of the filtering modules 753a and 753b are similar to those of the filtering module 653a of FIG. 8A. The operations of the counting modules 753c and 753d are similar to those of the counting module 653b of FIG. 8A. In this embodiment, the filtering and counting module 753 can simultaneously filter and count the first data (data1) and the second data (data2). The filtering module 753a and the counting module 753c are used to determine the serial result signals Checki and Checks of the first data (data1). The filtering module 753b and the counting module 753d are used to determine the serial result signals Checki and Checks of the second data (data2). The serial result signal Checki is about the result of determining whether the first data (data1) is included in a specified input region, and the serial result signal Checki is about the result of determining whether the second data (data2) is included in the specified input region. After the serial result signal Checki is accumulated by the accumulator 781, the updated counting value is stored in the counting result memory 77a. The serial result signal Checks is about the result of determining whether the first data (data1) is included in a specified symmetric region, and the serial result signal Checks is about the result of determining whether the second data (data2) is included in the specified symmetric region. After the serial result signal Checks is accumulated by the accumulator 782, the updated counting value is stored in the counting result memory 77b. It is noted that the number of the simultaneously-inputted data points and the number of the counting engines may be altered according to the practical requirements. More especially, plural counting engines may be integrated into a configurable counting engine (CCE). Since plural filtering and counting modules are combined together, the configurable counting engine can analyze the data points along more data dimensions at a faster speed or accelerate the analyzing speed.

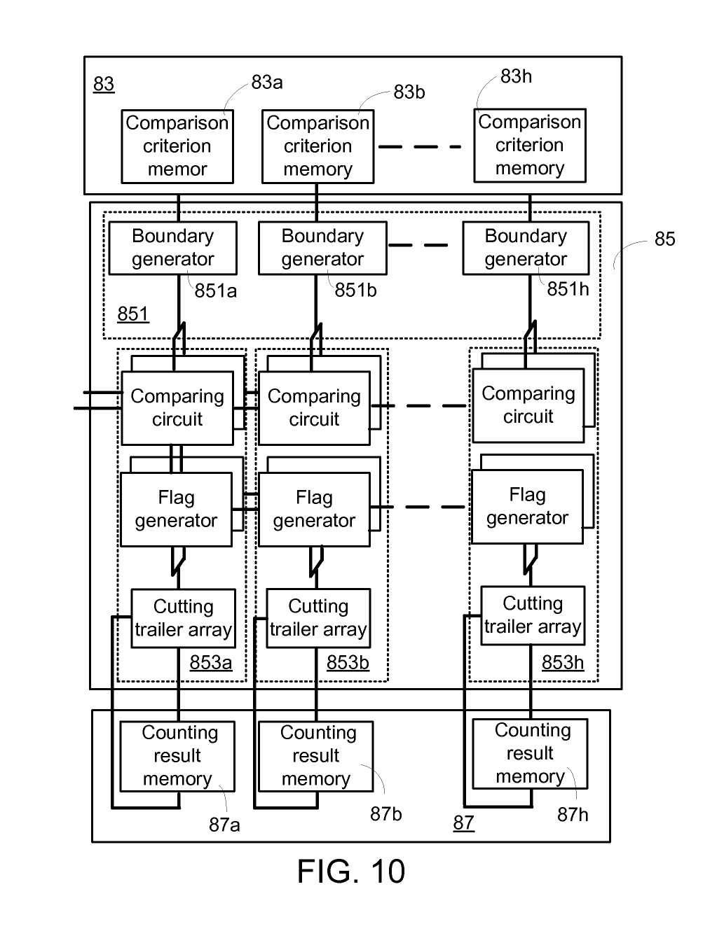

FIG. 10 is a schematic functional block diagram illustrating a BSP system in a multi-dimensional data space according to a further embodiment of the present invention. In this embodiment, the boundary generating module 851 includes eight boundary generators 851a˜851h, the counting engine 85 includes eight filtering and counting modules 853a˜853h, and the comparison criterion storage memory 83 includes eight comparison criterion memories 83a˜83h corresponding to the eight filtering and counting modules 853a˜853h. Moreover, the counting result memory 87 includes eight counting result memories 87a˜87h corresponding to the eight filtering and counting modules 853a˜853h. The counting engine 85 is configurable. That is, the comparison criterion memories 83a˜83h can be configured according to the data dimensions of the data points. Consequently, the filtering and counting modules 853a˜853h are classified into one or more partition groups. The filtering and counting modules in the same partition group are connected with each other in series. Since the filtering and counting modules are connected with each other in series, the number of data dimensions to be filtered by counting engine 85 is higher than the number of data dimension to be filtered by a single filtering and counting module.

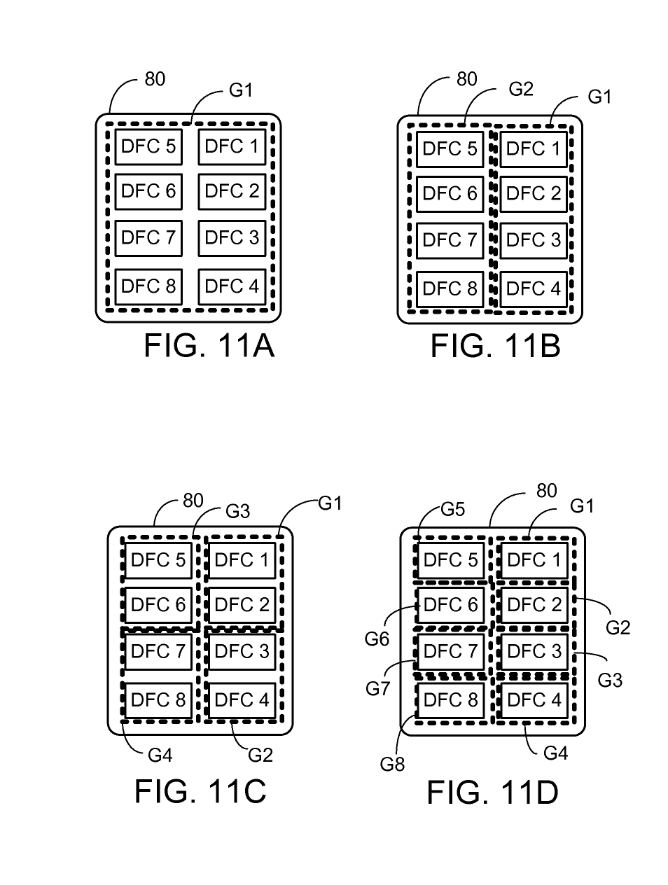

FIGS. 11A, 11B, 11C and 11D schematically illustrate some examples of configuring the counting engine of the BSP system of the present invention. For example, each filtering and counting module can process 128 data dimensions. Please refer to FIG. 11A. In case that the filtering and counting modules of the counting engine 80 are configured in a first mode (Mode 1), the eight filtering and counting modules DFC1, DFC2, DFC3, DFC4, DFC5, DFC6, DFC7 and DFC8 are classified into one partition group G1. Consequently, the counting engine 80 can count the data points in 1024 data dimensions (i.e., 128×8=1024). Please refer to FIG. 11B. In case that the filtering and counting modules of the counting engine 80 are configured in a second mode (Mode 2), the eight filtering and counting modules DFC1, DFC2, DFC3, DFC4, DFC5, DFC6, DFC7 and DFC8 are classified into two partition groups G1 and G2. The first partition group G1 contains the filtering and counting modules DFC1, DFC2, DFC3 and DFC4. The second partition group G2 contains the filtering and counting modules DFC5, DFC6, DFC7 and DFC8. Consequently, the counting engine 80 can simultaneously count two groups of data points in 512 data dimensions (i.e., 128×4=512). Please refer to FIG. 11C. In case that the filtering and counting modules of the counting engine 80 are configured in a third mode (Mode 3), the eight filtering and counting modules DFC1, DFC2, DFC3, DFC4, DFC5, DFC6, DFC7 and DFC8 are classified into four partition groups G1, G2, G3 and G4. The first partition group G1 contains the filtering and counting modules DFC1 and DFC2. The second partition group G2 contains the filtering and counting modules DFC3 and DFC4. The third partition group G3 contains the filtering and counting modules DFC5 and DFC6. The fourth partition group G4 contains the filtering and counting modules DFC7 and DFC8. Consequently, the counting engine 80 can simultaneously count four groups of data points in 256 data dimensions (i.e., 128×2=256). Please refer to FIG. 11D. In case that the filtering and counting modules of the counting engine 80 are configured in a fourth mode (Mode 4), the eight filtering and counting modules DFC1, DFC2, DFC3, DFC4, DFC5, DFC6, DFC7 and DFC8 are classified into eight partition groups G1, G2, G3, G4, G5, G6, G7 and G8. The partition groups G1, G2, G3, G4, G5, G6, G7 and G8 contain the filtering and counting modules DFC1, DFC2, DFC3, DFC4, DFC5, DFC6, DFC7 and DFC8, respectively. Consequently, the counting engine 80 can simultaneously count eight groups of data points in 128 data dimensions.

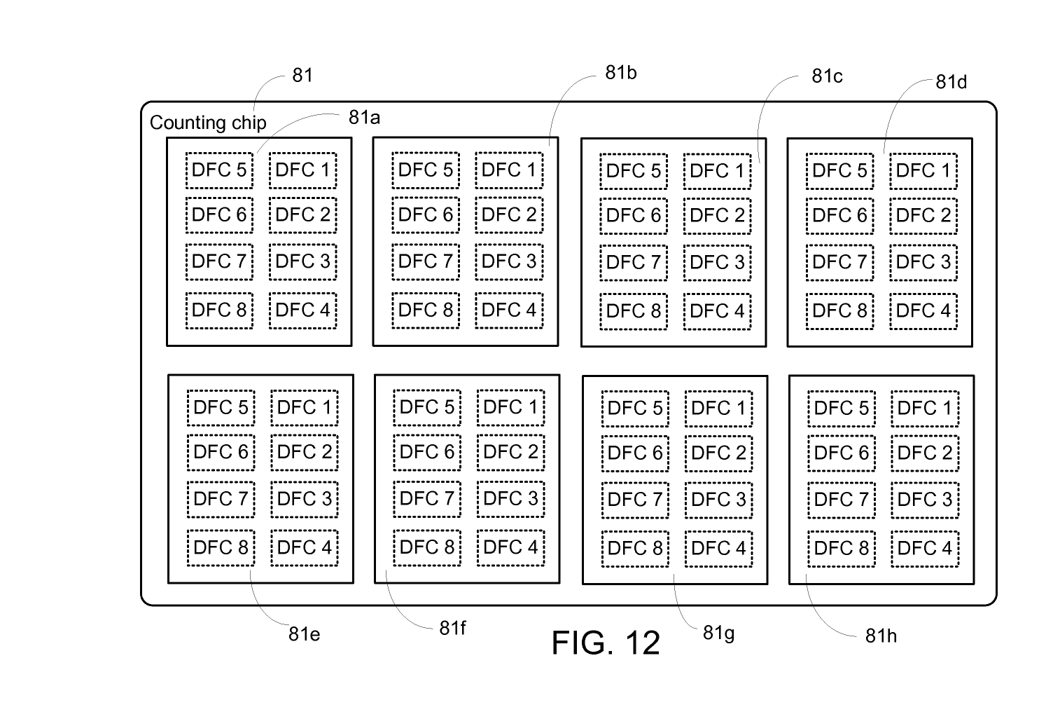

FIG. 12 schematically illustrates a counting chip with plural configurable counting engines. In this embodiment, the counting chip 81 includes eight counting engines 81a, 81b, 81c, 81d, 81e, 81f, 81g and 81h. Each counting engine includes eight filtering and counting modules DFC1, DFC2, DFC3, DFC4, DFC5, DFC6, DFC7 and DFC8. It is noted that the number of the counting engines of the counting chip and the number of the filtering and counting modules of each counting engine may be altered according to the practical requirements.

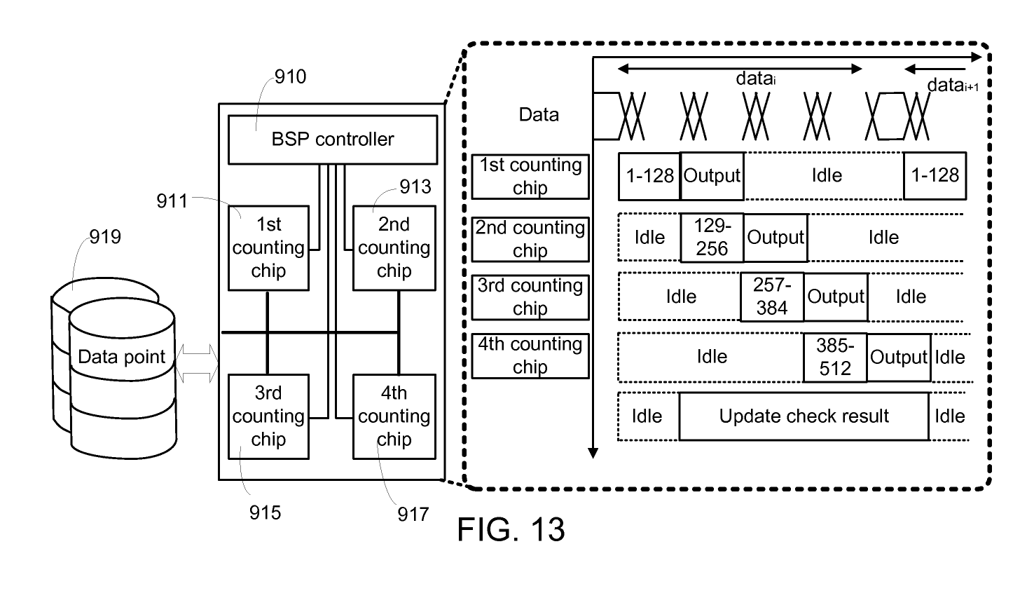

FIG. 13 schematically illustrates the architecture of a BSP system with plural serially-connected counting chips according to an embodiment of the present invention. The plural counting chips are connected with each other in series in order to count the data points along more data dimensions. After the data point from an external storage device 919 is received by the BSP controller 910, the data point is transmitted to a first counting chip 911, a second counting chip 913, a third counting chip 915 and a fourth counting chip 917. The first counting chip 911 determines whether the dimension value of the data point along the data dimensions 1˜128 complies with the filtering condition. The second counting chip 913 determines whether the dimension value of the data point along the data dimensions 129˜256 complies with the filtering condition. The third counting chip 915 determines whether the dimension value of the data point along the data dimensions 257˜384 complies with the filtering condition. The fourth counting chip 917 determines whether the dimension value of the data point along the data dimensions 385˜512 complies with the filtering condition.

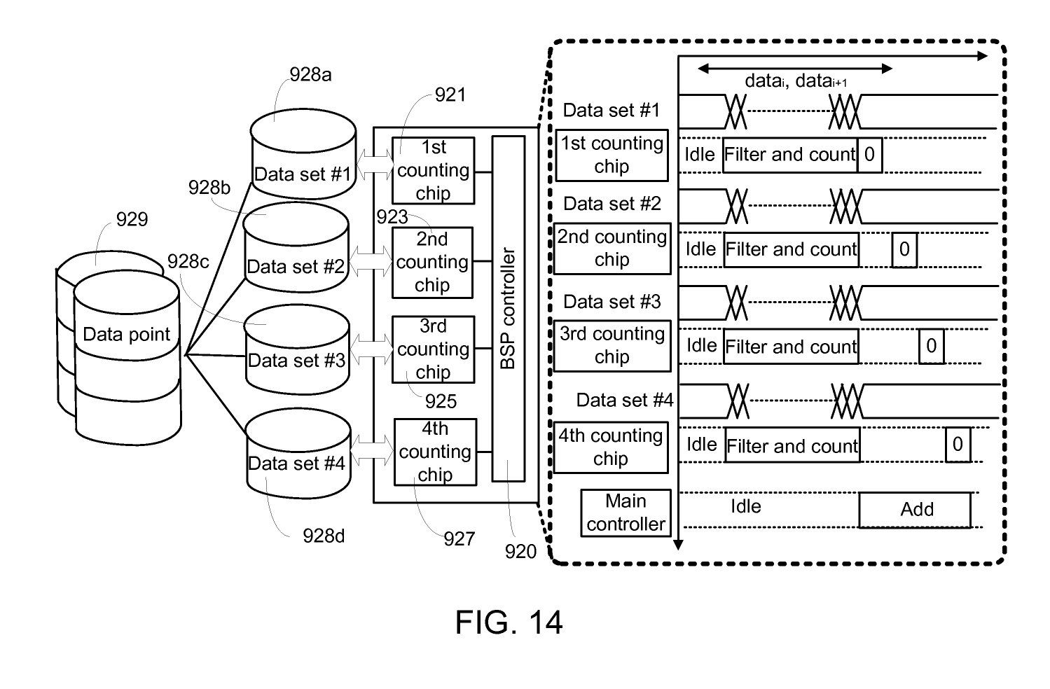

FIG. 14 schematically illustrates the architecture of a BSP system with plural parallel-connected counting chips according to an embodiment of the present invention. The plural counting chips are connected with each other in parallel in order to increase the speed of counting the data points. For example, M data points are divided into four data sets 928a, 928b, 928c and 928d, wherein each data set contains (¼×M) data points. The identical boundary information are inputted to the four counting chips 921, 923, 925 and 927. Each of the counting chips 921, 923, 925 and 927 calculates only (¼×M) data points. After the counting results of the four counting chips are added up, the BSP controller 910 performs the sequent determination. By connecting the plural counting chips in parallel, the number of data points to be calculated by the single counting chip is reduced. Under this circumstance, the overall duration of counting the data points is further reduced.

Moreover, the architecture of FIG. 13 and the architecture of FIG. 14 may be combined together through pipelines in order to increase the overall counting speed. For example, in a first time interval, the first counting chip determines whether the dimension value of the data points of the first data set along the data dimensions 1˜128 comply with the filtering condition.

In a second time interval, the first counting chip determines whether the dimension value of the data points of the second data set along the data dimensions 1˜128 comply with the filtering condition, and the second counting chip determines whether the dimension value of the data points of the first data set along the data dimensions 129˜56 comply with the filtering condition.

In a third time interval, the first counting chip determines whether the dimension value of the data points of the third data set along the data dimensions 1˜128 comply with the filtering condition, the second counting chip determines whether the dimension value of the data points of the second data set along the data dimensions 129˜256 comply with the filtering condition, and the third counting chip determines whether the dimension value of the data points of the first data set along the data dimensions 257˜384 comply with the filtering condition. The rest may be deduced by analogy.

From the above descriptions, the present invention provides a Bayesian sequential partition system capable of accelerating counting the data point number in several aspects. For example, the number of the sub-regions to be counted is reduced by subtraction, the data point numbers of the input region and the symmetric region are simultaneously calculated, or two data points are simultaneously inputted. Moreover, the present invention further includes a counting engine with simplified and configurable circuitry architecture. In case that the Bayesian sequential partition system includes a parallel processing mechanism, the overall counting speed is further enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A counting engine for a Bayesian sequential partition system in a D-dimensional data space, the counting engine comprising:
a filtering module for comparing at least one under-test data point with D boundary information corresponding to a sub-region, and consequently generating D flag sets; and
a counting module connected with the filtering module, for determining whether the at least one under-test data point lies in the sub-region, and consequently generating a result signal, wherein a counting value corresponding to the sub-region is selectively accumulated by the counting module according to the result signal.

2. The counting engine as claimed in claim 1, wherein the counting engine is electrically connected with a data point storage unit, wherein the filtering module receives plural data points from the data point storage unit and selects the at least one under-test data point from the plural data points.

3. The counting engine as claimed in claim 2, wherein after all of the plural data points are sequentially selected as the at least one under-test data point, the accumulated counting value indicates a number of the data points included in the sub-region.

4. The counting engine as claimed in claim 1, further comprising a boundary generating module, electrically connected with the filtering module and a comparison criterion memory, for receiving a region information corresponding to the sub-region and accordingly generating the D boundary information.

5. The counting engine as claimed in claim 4, wherein the filtering module comprises:
a comparing circuit electrically connected with the boundary generating module for receiving the D boundary information, wherein after plural dimension values of the under-test data point along D data dimensions of the D-dimensional data space are compared with the D boundary information, the comparing circuit generates D comparing result sets; and
a flag generator electrically connected with the comparing circuit and the counting module, wherein the flag generator generates the D flag sets according to the D comparing result sets.

6. The counting engine as claimed in claim 5, wherein the counting module comprises:
at least one cutting trailer for determining D filtering ranges and corresponding D range signals according to the D flag sets, and generating the result signal according to the D range signals; and
an accumulator, for counting up the counting value when the result signal is activated.

7. A Bayesian sequential partition system in a multi-dimensional data space, connected with a data point storage unit, wherein plural dimension values of plural data points along plural data dimensions are stored in the data point storage unit, the Bayesian sequential partition system comprising:
a controller for generating a region information corresponding to a region;
a comparison criterion memory connected with the controller for temporarily storing the region information;
a counting engine connected with the comparison criterion memory and the data point storage unit, wherein the counting engine cuts the region into a first sub-region and a second sub-region according to a first simulated cut, and the counting engine generates a filtering condition for filtering the plural data points according to the region information and counts a first number of data points in the first sub-region; and
a counting result memory, connected with the counting engine and the controller, for temporarily storing the first number and transmitting the first number to the controller,
wherein the controller records a second number of the data points which are included in the region and obtains a third number of data points by subtracting the first number from the second number, wherein the controller realizes that the third number of data points are included in the second sub-region, and the controller acquires a first cutting weight corresponding to the first simulated cut according to the first number and the third number.

8. The Bayesian sequential partition system as claimed in claim 7, wherein the counting engine comprises:
a boundary generating module connected with the comparison criterion memory for generating plural boundary information according to the region information;
a filtering module connected with the boundary generating module, for establishing the filtering condition to filter the plural data points according to the plural boundary information, and consequently determining whether the plural data points are included in the first sub-region; and
a counting module connected with the filtering module, wherein when the filtering module determines that one of the data points is included in the first sub-region, a counting value corresponding to the first sub-region is counted up.

9. The Bayesian sequential partition system as claimed in claim 8, wherein the filtering module comprises:
a comparing circuit for determining a first filtering range of the region according to the plural boundary information and receiving a first data point of the plural data points, wherein after the first filtering range and the first data point are compared with each other, the comparing circuit generates plural comparing signals; and
a flag generator for receiving the plural comparing signals and consequently generating plural flag signals.

10. The Bayesian sequential partition system as claimed in claim 9, wherein the counting module comprises:
a cutting trailer for determining whether the first data point is included in the first filtering range according to the plural flag signals, wherein if the plural dimension values of the first data point comply with the filtering condition, the first data point is included in the first sub-region, so that the result signal is activated by the cutting trailer; and
an accumulator, for counting up the counting value when the result signal is activated.
